(19) United States
(12) Patent Application Publication
(10) Pub. No.: US 2006/0274828 A1
(43) Pub. Date: Dec. 7, 2006

(54) High capacity surveillance system with fast search capability

(75) Inventors: Michael Siemens, Fort Collins, CO (US); David Desormeaux, Fort Collins, CO (US); Matt Siemens, Wildwood, MO (US); Scott Ruff, Fort Collins, CO (US)

Correspondence Address: PATTON BOGGS, 1660 LINCOLN ST, SUITE 2050, DENVER, CO, 80264, US

(73) Assignee: A4S Security, Inc., Loveland, CO (US)

(21) Appl. No.: 11/502,062

(22) Filed: Aug. 9, 2006

Related U.S. Application Data
(63) Continuation-in-part of application No. 10/285,862, filed on Nov. 1, 2002.
(60) Provisional application No. 60/415,905, filed on Oct. 3, 2002.
(60) Provisional application No. 60/335,926, filed on Nov. 1, 2001.
(60) Provisional application No. 60/776,804, filed on Feb. 24, 2006.
(60) Provisional application No. 60/719,052, filed on Sep. 20, 2005.

(51) Int. Cl. H04N 11/04; H04N 7/18; H04N 9/47; H04N 7/12; H04N 11/02; H04B 1/66

(52) U.S. Cl. 375/240.01; 348/143; 348/148

(57) ABSTRACT

A surveillance system having a plurality of MPEG compressed data streams each originating from a separate video/audio source. The data is stored on hard disk and streamed to tape in real time with time set markers readable independent of the compressed video signal. The data is partitioned on the tape, each partition including a plurality of data blocks, each data block including synchronized frames from each stream, a stream map, telemetry information, roster information and tape positioning data. Each partition includes a duplicate stream map and a duplicate partition directory, and each block within the partition includes duplicate telemetry information. Set marks readable in fast forward or rewind mode, are placed every second on the tape in a position just before the duplicate telemetry and a file mark is placed just before the duplication partition directory. The tape cassette includes an EEPROM, which holds a duplicate partition directory and redundant directory information useful for searching. In case of tape error, the tape automatically restores itself when inserted into the tape deck.

### CROSS-REFERENCE TO RELATED APPLICATIONS

This Application is a Continuation-in-part of U.S. patent application Ser. No. 10/285862 filed on Nov. 1, 2002, which claims the benefit of U.S. Provisional Patent Application 60/415905 filed on Oct. 3, 2002, and U.S. Provisional Patent Application 60/335926 filed on Nov. 1, 2001. This Application also claims the benefit of U.S. Provisional Patent Application 60/719052 filed on Sep. 20, 2005, and U.S. Provisional Patent Application 60/776804 filed on Feb. 24, 2006. All of the referenced applications are incorporated by reference to the same extent as though fully disclosed herein.

### FIELD OF THE INVENTION

The invention relates to the field of audio/visual surveillance, and more particularly, but not byway of limitation, to such a system that is compact enough to be carried in a vehicle, such as a patrol car, and is capable of writing a high volume of data to digital tape such that high speed searching can be employed and is highly fault-tolerant.

### BACKGROUND OF THE INVENTION

Audio/visual surveillance systems that are sufficiently compact to be carried in a vehicle, such as a police or patrol car, are well known. These systems generally involve recording audio and visual information on a local recording system in the vehicle, transmitting the audio and visual information to a central command facility for review and/or recording, or combinations of the foregoing. See U.S. Pat. No. 6,037,977 issued May 14, 2000 to Roger Peterson. These systems also often include the acquiring and storing of location information, e.g., the geographical position of the patrol car. See U.S. Pat. No. 4,152,693 issued May 1, 1979 to Ashworth, Jr. These systems have been developed in response to the need for rapidly informing central command facilities, such as police headquarters, of emergency situations and the audio and visual details thereof, and the need for obtaining and preserving audio and visual evidence of crimes, emergencies, and other events that involve police action or participation. For example, to successfully prosecute an individual accused of a crime, the law of the United States of America requires that due process be shown. Audio and visual records can be of critical assistance in proving probable cause for stopping or arrest, and other due process elements.

Audio/video surveillance inherently involves a problem of data transmission and storage, because video data files are generally very large and surveillance must occur for significant periods of time, often days or weeks. Generally, this is addressed in surveillance systems by either saving only a few video frames per second, by storing frames for only a short time and then recycling the storage medium by recording over the previously stored data, or by storing or transmitting only portions of the surveillance data. See, for example, U.S. Pat. No. RE37,508 issued Jan. 15, 2002 to Taylor et al.; U.S. Pat. No. 6,211,907 issued Apr. 3, 2001 to Scaman et al.; and U.S. Pat. No. 6,456,321 issued Sep. 24, 2002 to Ito et al. A common solution to the capacity problem is to put the control of the recording devices at the fingertips of the police officers and/or headquarters and have them record only when it is required. See U.S. Pat. No. 6,037,977 referenced above. Surveillance systems also inherently require a system for rapid retrieval of data; and for this reason, most state-of-the-art systems data is stored on hard drives or other systems permitting random access. See, for example, U.S. Pat. No. 5,689,442 issued Nov. 18, 1997 to Swanson et al. However, hard drives are fragile if handled improperly, and downloading them without removing them takes so much time that it is unlikely to be done.

Audio/visual surveillance systems are employed in tens of thousands of patrol cars today. State-of-the-art systems, such as the device disclosed in the U.S. Pat. No. 6,037,977 patent mentioned above, give the police officer great flexibility with the multiple cameras and audio sources at his or her disposal. They include the latest technologies, including wireless transmitters, miniature cameras, removable hard drives, and geographical locators. Yet, the goal of having prompt communications with the officers in emergencies and reliable audio and visual evidence for use in court remains elusive. Often, in emergencies, police officers are responding to the situation and do not have time to activate the recording equipment. In most instances, due process evidence is not available because, by the time the systems are turned on, the probable cause evidence has come and gone. Even when the systems have been turned on, the resolution is often so poor that it either is useless or it takes a large amount of computer processing to enhance it to make it useable, or the hazards of police work combined with the fragility of high tech systems causes data to be lost.

In mission critical environments, such as those contemplated by mobile surveillance systems, tape is not a first choice, since, for all practical real-time purposes, the tape has been incapable of writing in a random access manner, unlike a hard disk that is a completely random access process. Typically, conventional streaming devices are problematic because losing any information for any reason at any point renders the remaining information beyond that point useless. For example, conventional analog or digital tape has stored thereon a directory or index of content stored on the tape, including start and stop information of content stored on the tape (e.g., streaming video). In the event that the directory or index information is corrupted or some portion of the content is destroyed, all content on the tape is lost. In the event that some portion of the content is destroyed, all content after the destroyed portion of the content is lost. In either situation, the lost content is generally unrecoverable. For these and other apparent reasons as understood in the art, tape systems have generally been avoided for use in mission critical environments, especially those utilized in harsh environments, such as mobile surveillance systems.

Conventional storage systems utilize storage mediums that are problematic for practical surveillance applications due to capacity limitations. As shown in Table A below, standard random access devices have limited capacity and/or have other serious limitations for practical surveillance applications used in harsh environments. DVD and CD-ROM have limitations in that recording is a once-only operation, and is not capable of start-stop recording. A hard disk can handle moderate shocks, but will be destroyed in a removable application if dropped. Although analog tape will continue recording during a shock, many undesirable artifacts are produced for several seconds after the initial shock.

TABLE A

| | | | Shock | Serious Error | Removable |
|---|---|---|---|---|---|
| Technology | Capacity | Recordable | Resistant | Recovery | Media |
| DVD | 8 Gigs | Yes, with | No | No | Yes |
| | | limitations | | | |
| Blue-Ray | 17 Gigs | No | No | No | Yes |
| HD-DVD | 35 Gigs | No | No | No | Yes |
| CD-ROM | 800 Megs Max | Yes, with | No | No | Yes |
| | | limitations | | | |
| Hard Disk | 100's Of Gigs | Yes | To a degree | Yes | No |
| Analog tape | Equivalent To 4 | Yes | No | Yes | Yes |
| | Gigs | | | | |

To the extent that analog or even digital tape has been used for surveillance applications, conventional techniques for writing to these tapes are problematic for those interested in searching or seeking for content on the tapes. For example, it is generally understood that compression techniques may increase storage capacity of a storage media. In the event of using tape and writing recording time information in the compressed video content, a search of the tape for a particular time of the recorded video requires a system to uncompress the video, read the time stamp information, and determine whether the time stamp matches the time desired for the search. While such a search may operate up to four times normal playback time, in the case of having several hours of content stored on a tape, the search using the technique may take an excessive amount of time. Further, because compressed video using compression techniques such as MPEG-2 (Motion Picture Expert Group-2) is non-linear, searching using techniques other than conventional read search techniques results in an imprecise and timely manual search effort.

As described above, conventional techniques for reading compressed video include reading the video data and determining a time stamp value from the video compression scheme written thereon. This conventional technique for reading time stamp information from video compression introduces a few problems.

First, current tape deck technology offers the ability to read four times faster than real-time. While this enhanced reading speed offers improved searching capabilities, current tape decks are also capable of physically seeking at 400 times the speed of real-time. This means that reading the time stamps written to the digital tape using compression is a relatively slow process compared to the tape deck's ability to seek. Because of the non-linear writing using compression schemes, using the seek function of current tape decks on compressed video is simply not possible.

Second, the act of reading compressed video data to read time-stamp values assumes that both the recording and playback schemes have an intimate knowledge about how to parse and partially decompress the video to access these time-stamp values. While this knowledge between the recording and reading schemes appears to be straight forward, having to be limited to a tape deck having a certain format is problematic from a practical standpoint.

Third, a file directory is typically located at the front of a tape and includes a count value of tape marks that are used to indicate the start of files stored on the tape (e.g., data files). Continuous streaming of video onto a tape does not provide for such tape marks. The original intent of setting file marks, which are now called “set marks”, was to mark the start position of files so that a tape deck may quickly find a file on the digital tape by counting file marks. However, if the tape directory at the front of the digital tape is lost, the content of the tape is effectively lost because all context of what is on the tape is lost, and therefore fatal to further tape usage.

Accordingly, there is a need for a recording system that provides high resolution in a compact, rugged, and reliable system that stores high volumes of data in a high fault-tolerant manner that is capable of being searched at high rates of speed.

### BRIEF SUMMARY OF THE INVENTION

In overcoming the shortcomings of conventional storage systems for surveillance systems, the principles of the present invention provide for a reliable system that stores compressed video in a high-capacity, fault-tolerant manner that is capable of being searched at high rates of speed. The system includes markers that can be read independent of the compressed video, which markers are correlated to specific video recorded on the media. The markers can be read at a much higher rate of speed than the compressed video, thus allowing specific portions of the video to be found quickly.

In providing such a system, surveillance content maybe written to digital tape or other medium in partitions, preferably with directory redundancy and preferably with markers that maybe accessed independent of the tape content. The partitions form a function similar to the bulkheads in a ship; i.e., they limit the loss of data in case of corruption of a small part of the recording. The system also permits the streaming of multiple video signals, each from a different video source, onto a single digital medium, preferably a digital tape. A portion of each stream is written into each partition. The different streams may have different compression formats and different transfer rates. The recorded data is preferably self-authenticating. The surveillance system may be operated by accessing a web site and operating the system using a user interface on the web site.

The invention provides a surveillance system, comprising: a source of a video signal; a video signal compression system electrically connected to the source and providing a compressed video signal; a marker generator for generating markers independent of the compression, the markers indicative of specific content on the medium; and a digital video recorder electrically connected to the compression system for writing the compressed video signal to a recording medium and for writing the marker to the medium, the markers being readable independent of the compressed video signal. Preferably, the markers are timing markers recorded on the medium at predetermined time intervals. Preferably, the surveillance system also includes a marker read system for reading the markers. Preferably, the marker read system is selected from an electronic reader and an optical reader. Preferably, the marker read system generates a sound. Preferably, the marker read system comprises a timing marker counter for counting the timing markers without reading the compressed video signal. Preferably, the timing markers are spaced on the tape one second or less apart from each other. Preferably, the system includes a marker reader for generating sound signals from the markers. Preferably, the specific content comprises directory information regarding the location of data on the medium. Preferably, data comprises telemetry signals. Preferably, the medium is a digital tape. Preferably, the telemetry signals are recorded on the tape following the marker signals. Preferably, the recorder is a digital tape recorder and the recording medium is a digital tape having a semiconductor memory incorporated in it, the compressed video signal is written to the tape, and the markers are written to the semiconductor memory. Preferably, the surveillance system is mounted in a mobile vehicle. Preferably, the video compression comprises MPEG compression, which preferably is selected from the group consisting of MPEG-1, MPEG-2, MPEG-4 and H.264. Preferably, the video signals are high density (HD) video signals.

The invention also provides a surveillance method, comprising: generating a video signal containing surveillance images; electronically compressing the video signal into a compressed video signal; generating data associated with the compressed video signal; recording the compressed video signal and the data onto a digital tape cassette, the tape cassette having a semiconductor memory incorporated into it; and writing markers into the semiconductor memory, the markers designating where specific portions of the compressed video signal or specific portions of the is located on the tape. Preferably, the method further comprises reading the markers without reading the compressed video signal. Preferably, the generating data includes generating a start time and an end time associated with the compressed video signal. Preferably, the method further comprises: partitioning the compressed video signal into a plurality of partitions, each the partition including a portion of the compressed video signal; and using the markers to find a particular one of the partitions. Preferably, there are a plurality of the video signals, the electronically compressing comprises forming a plurality of streams of compressed video signals, each stream corresponding to a different source of the video signals, the method further comprising using the timing markers to locate one or more of the streams. Preferably, the data further comprises telemetry data associated with the video signal and the method further comprises using the markers to find the telemetry information on the tape. Preferably, the telemetry data includes time of day. Preferably, the generating a video signal is performed in a mobile vehicle. Preferably, the telemetry data includes one or more of the speed of the vehicle, the direction of the vehicle, the elevation of the vehicle, and an identification of the vehicle. Preferably, the video compression is MPEG compression, which preferably is selected from the group consisting of MPEG-1, MPEG-2, MPEG-4 and H.264. Preferably, the video signals are high density (HD) video signals.

The invention also provides a surveillance method, comprising: generating a video signal containing surveillance images; electronically compressing the video signal into a compressed video signal; recording the compressed video signal onto a digital tape; and writing timing markers, independent of the compressed video signal, onto the digital tape, the timing markers being spaced on the tape in a predetermined time pattern. Preferably, the method further comprises counting the markers written onto the tape without reading the at least one compressed video signal. Preferably, the writing timing markers comprises writing the markers in a periodic manner on the tape. Preferably, the timing markers are spaced two seconds or less apart on the tape and more preferably one second or less apart on the tape. Preferably, the method further comprises generating a sound from the timing markers. Preferably, the method comprises counting the timing markers without reading the compressed video signal. Preferably, the method comprises partitioning the compressed video signal into a plurality of partitions, each the partition including a portion of the compressed video signal; and using the timing markers to find a particular one of the partitions. Preferably, the method comprises receiving a time of day associated with the compressed video signal; determining the number of the markers from a position of the tape to the compressed video signal associated with the time of day; and moving the tape the determined number of markers and reading the compressed video signal. Preferably, the recording further comprises recording on the tape telemetry data associated with the video signals, and the method further comprises using the timing markers to find the telemetry data on the tape.

In another aspect, the invention provides a method of video surveillance, the method comprising: providing one or more video signals; compressing the one or more video signals to form a plurality of streams of compressed video data; and streaming a first of the video streams to via a first video channel while streaming a second of the video streams via a second video channel; wherein the first and second video channels each has a different transfer rate. Preferably, the method further comprises placing a time indication on each of the streams, which time indication is effective to permit the streams to be synchronized on playback. Preferably, the transfer rate of the first and second video streams differ by 10 megabytes per second (MBPS) or more. Preferably, the transfer rate is variable on at least one of the channels. Preferably, one of the video streams is a conventional density video stream and another is a high density (HD) video stream. Preferably, the compressing comprises comprising compressing a first of the video streams according to a first video compression standard and compressing a second of the video streams according to a second video compression standard, wherein the first and second video compression standards are different. Preferably, the first standard comprises MPEG-1 and the second standard is selected from MPEG-2, MPEG-4 and H.264.

In still another aspect, the invention provides a method of video surveillance comprising: generating a video signal containing surveillance images; generating self-authentication data; electronically compressing the video signal into a compressed video signal; recording the compressed video signal and the authentication data onto a digital medium; and self-authenticating the recording of the compressed video data using the self-authentication data. Preferably, the generating self-authentication data comprises generating a hash value. Preferably, the generating self-authentication data comprises generating time data from a GPS source or an atomic clock and the recording comprises recording the time data on the medium at intervals of one second or less. Preferably, the recording is performed at intervals of one-tenth of a second or less, and more preferably at intervals of one-one-hundredth of a second or less.

In yet a further aspect, the invention provides a method of operating a video surveillance system, the surveillance system including: a video camera providing a video signal; a video signal compression system electrically connected to the camera and providing a compressed video signal; and a digital video recorder electrically connected to the compression system for writing the compressed video signal to a recording medium; the method comprising: accessing a web site via a computer, and operating the surveillance system via a program located on the web site. Preferably, the operating comprises manipulating a user interface on the web site. Preferably, the user interface accesses only the predetermined local surveillance files. Preferably, the method further comprises customizing the functionality and look of the user interface. Preferably, the method further comprises providing built-in full SSL security Web server technology on the web site. Preferably, in the accessing is performed using a wireless system. Preferably, the video camera is located on a mobile vehicle. Preferably, the surveillance system is located on a mobile vehicle.

The above and other advantages of the present invention maybe better understood from a reading of the following description of the preferred exemplary embodiments of the invention taken in conjunction with the drawings.

### BRIEF DESCRIPTION OF THE DRAWINGS

FIG. 1 is a block diagram of a preferred embodiment of the invention;

FIG. 2 is a schematic view showing the location of the audio, visual, and satellite sources and wireless transmissions associated with the invention;

FIG. 3 is a schematic diagram showing the electronics enclosure of FIG. 1 and the airflow through the enclosure;

FIG. 4 is a diagram illustrating the synchronization of MPEG audio/video according to the invention;

FIG. 5 is a schematic diagram of a data packet according to one preferred embodiment of the invention;

FIG. 6 is a schematic diagram showing the relationships between the software and hardware components of the embodiment of FIG. 1;

FIG. 7 is a schematic diagram showing the details of the file system and caching scheme of the embodiment of FIG. 1;

FIG. 8 is a diagram of a surveillance network in accordance with the principles of the present invention is utilized;

FIG. 9 is a schematic illustration of how the system of FIG. 8 captures a variety of video/audio streams and multiplexes them into a sliding window storage system;

FIG. 10 is a high-level schematic diagram showing a more detailed internal structure of the video/audio capture system according to the invention

FIGS. 11A and 11B together show a diagram illustrating the flow of video/audio data, surveillance data, and control data in an exemplary system according to the invention;

FIG. 12 is a diagram illustrating an exemplary partition directory and the information stored in the directory,

FIG. 14 is a block diagram illustrating the index redundancy feature of an exemplary surveillance system according to the invention;

FIG. 15 is a diagram of an exemplary system for capturing and writing data onto digital tape;

FIG. 16 is a diagram of an exemplary digital tape optionally utilized in accordance with the principles of the present invention to store content in a fault-tolerant manner and for fast retrieval of directory information;

FIG. 17 is a flow chart describing an exemplary process for capturing and writing surveillance data onto a digital tape in a fault-tolerant manner,

FIG. 18 illustrates one embodiment of how the system checks itself for errors and corrects them upon insertion of the tape cassette into the tape deck;

FIG. 19 illustrates one embodiment of how the tape self-corrects during the write function; and

FIG. 20 illustrates one embodiment of how the tape self-corrects during a read function.

### DETAILED DESCRIPTION OF THE INVENTION

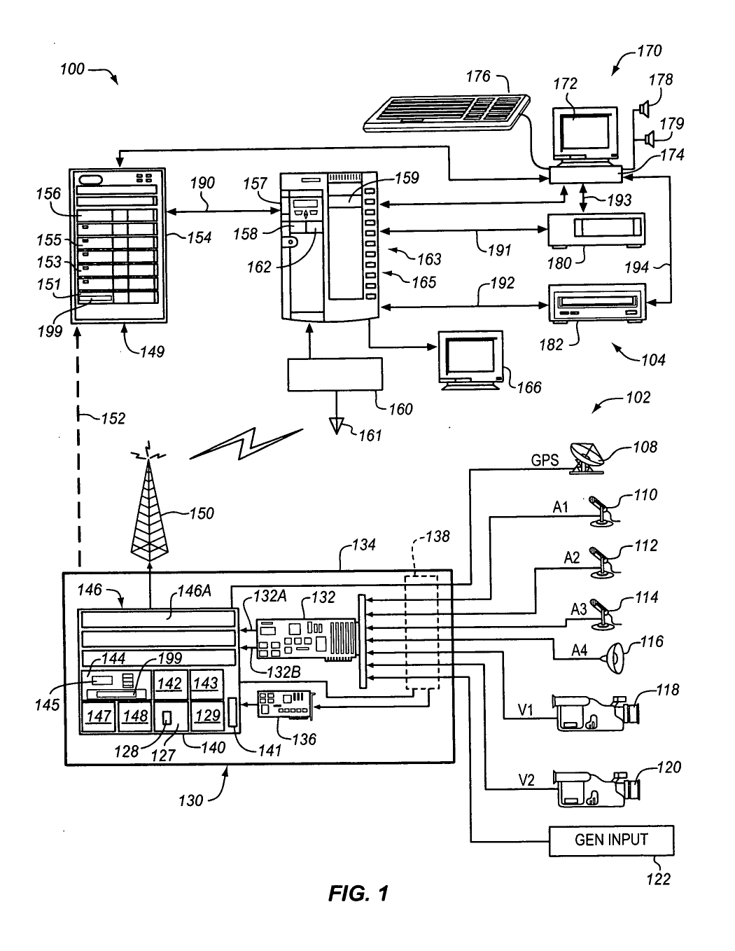

FIG. 1 is a block diagram view of a preferred embodiment of a surveillance system 100 according to the invention. Surveillance system 100 includes a patrol unit 102 and a command center unit 104. In one aspect of the invention, high resolution video data for an entire patrol car shift is recorded on a tape 199 in recorder 144, and, at the end of the shift, the tape 199 is removed by the patrol officer and transferred, as indicated by arrow 152, to a master sled bay 154 in the command unit 104. In this specification we shall at times refer to video/audio, audio/visual, or simple video for short, all of which mean the same thing unless otherwise clear from the context. That is, “video” is intended to include both visual and audio data. Once in the sled bay 154, the data may be smoothly retrieved by buffering it temporarily in hard drives 158, monitored on monitor 172, stored on a tape via recorder 180, or archived on a DVD or CD via a DVDR or CDR recorder 182. In another aspect of the invention, lower resolution audio/visual data is transmitted via transmitter 147 and antenna 150 to command center antenna 161 and receiver 160 where it is buffered on hard drives 159 and monitored on monitor 166. It also maybe stored via tape drive 180 or DVDR/CDR 182. In addition, other information is input into system 100, such as geographical positioning information from geographical positioning system (GPS) 108, and general information from a generalized input 122, which general information can be information related to an event, such as shotgun removed from cradle, chase, robbery in progress, accident, explosion, and other information, such as vehicle speed, vehicle direction, vehicle elevation, vehicle or camera identification or any other information useful for surveillance, law enforcement, emergency response or associated with the video/audio being recorded. It should be understood that patrol unit 102 represents an exemplary application of the invention. The invention can be advantageously applied in any mobile vehicle, such as a bus, a car, a truck, a train, an airplane, a boat or a ship. As will be seen below, the invention can also be applied in a stationary environment, such as a retail store, a warehouse, a public building, a hospital, an operating room, a classroom, or any other environment where high-resolution fail-safe surveillance would be of advantage.

Turning now to the details of the invention, patrol unit 102 includes a satellite signal receiver 108, a first audio source 110, a second audio source 112, a third audio source 114, a fourth audio source 116, a first video source 118, a second video source 120, a general input source 122, and an electronics box 130. Electronics box 130 includes a housing 134, a switch 138, which is optional and therefore is shown by dashed lines, an MPEG encoder 132, an MPEG encoder 136, and a computer 140. MPEG encoders 132 and 136 may be Mpeg-1, MPEG-2, MPEG-4, or H.264, and may have conventional resolution or high density (HD) resolution. High density resolution means any of the formats used or proposed for a resolution greater than the conventional NTSC resolution of 525 lines scanned at 29.97 frames per second with a horizontal resolution of 427 pixels. Computer 140 includes a solid state recorder/reader 127, solid state media 128, CD or DVD burner 129, parallel and serial ports 141, processor 142, RAM 143, a tape drive 144, a timing marker generator 145, a plurality of hard drives 146, a transmitter 147, and a receiver 148. Patrol unit 102 also includes antenna 150. Solid state recorder/reader is preferably a Flash or FeRAM recorder/reader, and solid state media 128 is preferably a Flash or FeRAM memory, though they may be any other suitable solid state system. Preferably, at least one of the media on which the video is recorded is removable; this maybe the tape 199, at least one of the hard drives 146A, or the solid state media 128. In some embodiments, there maybe more than one removable medium.

Command center unit 104 includes master sled bay 154, command center server 157, receiver 160, antenna 161, MPEG-1 monitor 166, computer 170, tape recorder 180, and DVDR recorder 182. As known in the art, master sled bay 154 is essentially a plurality of removable media drives, such as 151, 153, 155, and 156, along with control electronics. These drives may be tape drives, hard drives, solid state media drives, or any other drive for reading/recording on a removable media. Command server 157 includes processor 158, hard drives 159, RAM memory 162, MPEG decoders 163, and MPEG-1 decoder 165. Preferably, the hard drives 159 are organized into a RAID (Redundant Array of Inexpensive Disks) type storage system. Computer 170 includes monitor 172, electronics 174, including a processor and input and output cards as known in the art, and input device 176, which preferably is a keyboard. The various components of command unit 104 are connected by appropriate interfaces 190-194 as known in the art. Preferably, interfaces 190, 191, and 192 are SCSI interfaces.

In FIG. 1, only the components of the surveillance system 100 essential for understanding the invention are specifically shown. As known in the art, the system 100 will include many other electronic parts such as clocks, ports, busses, motherboards, etc., necessary for the functions described.

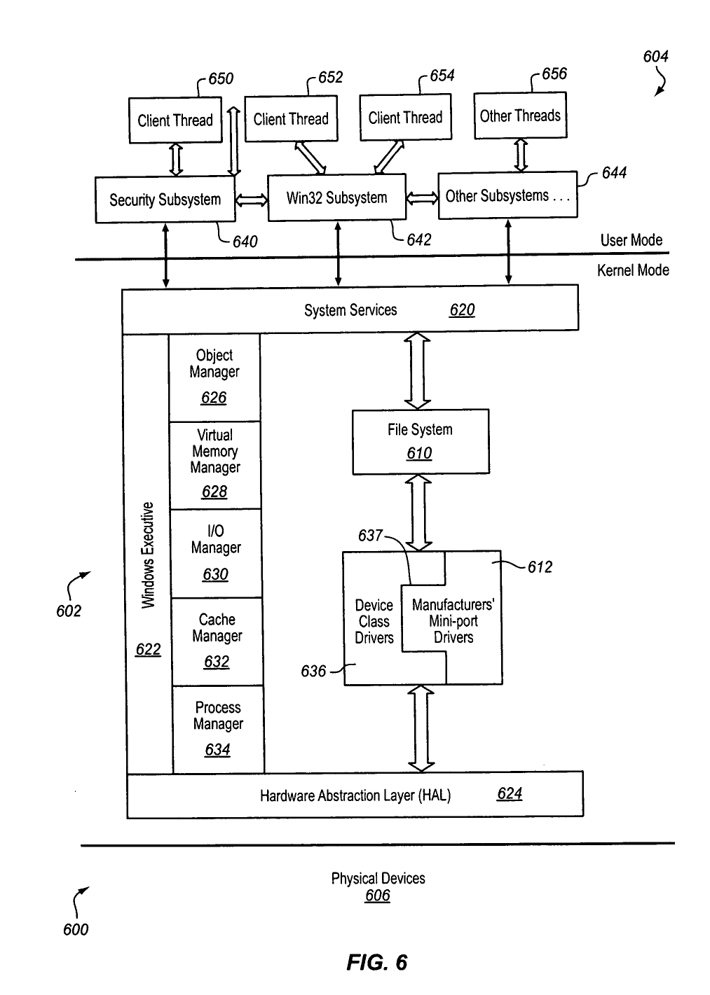

The invention operates as follows. The satellite antenna 108 receives a GPS (Geographic Positioning Signal) and time signal T from satellites in orbit. How such signals are produced and received is well known in the electronics art. The GPS and time signals are fed to a serial port 141. The time signal is used to periodically set the clock of computer 140. Periodically, the GPS signal is processed, as known in the art, to produce geographic positioning information, which is buffered and recorded as will be described in detail below (FIG. 6). In the preferred embodiment, the patrol car position is determined every five seconds. The audio sources 110-116 provide audio signals A1 through A4, and the video sources 118 and 120 provide video signals V1 and V2. Preferably, audio sources 110, 112, and 114 are microphones, and audio source 116 is an audio input that tracks the audio exchange with the police dispatcher via the patrol car radio. Video sources 118 and 120 are high-resolution video cameras. Signals A1 through A4 and V1 and V2 are directed to MPEG encoder card 132. Optionally, a switch 138 can direct a selected video signal and a selected pair of audio signals to MPEG encoder card 136. Switch 138 may be activated from within the patrol car, or it may be activated from the command center via receiver 148. Alternatively, a predetermined pair of signals A1 through A4 and a selected one of signals V1 and V2 may be directed to MPEG encoder 136, which preferably is an MPEG-1 encoder. Encoder card 132 is a dual decoder in that it decodes two channels 132A and 132B of MPEG signals. The encoded MPEG signals, which are preferably MPEG-2, from encoder 132 are buffered in hard drives 146 and written to a tape, preferably a cartridge tape, via recorder 144 as will be described in detail below. The encoded MPEG-1 signal from encoder 136 is buffered in RAM 143 and transmitted via transmitter 147 and antenna 150.

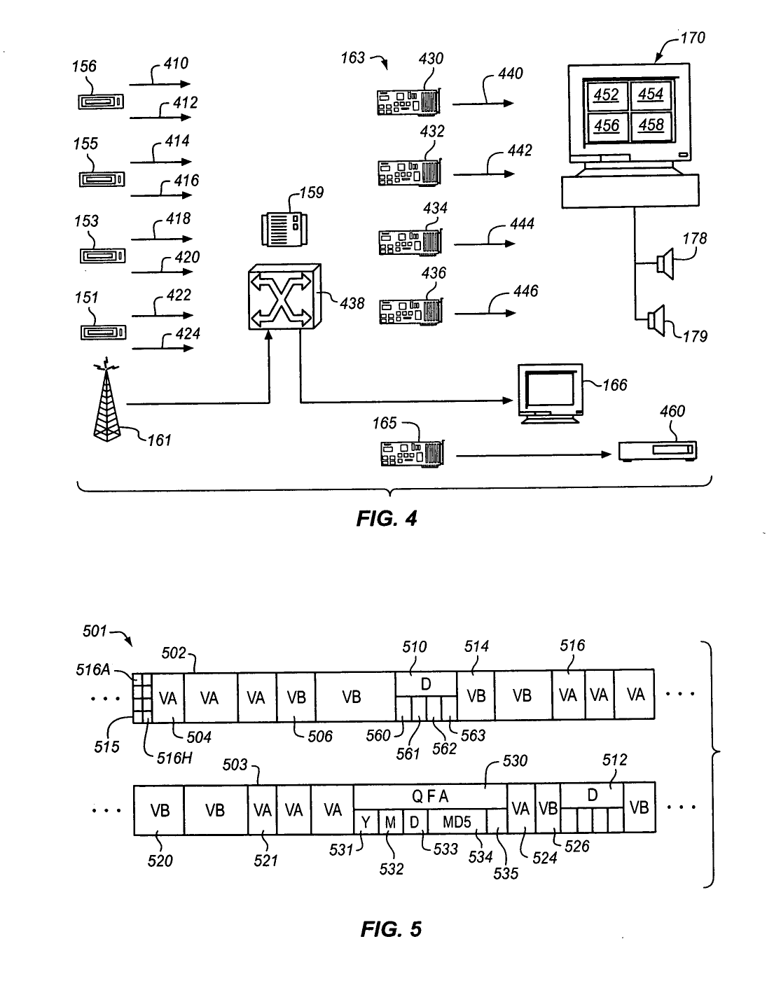

The encoded MPEG-1 signal is received via antenna 161 by receiver 160, processed by processor 158 as directed by software as described in more detail below, buffered in hard drives 159, decoded by MPEG-1 decoder 165, and displayed on MPEG-1 monitor 166. This process, as well as the activation of switch 138 in patrol unit 102, is controlled via computer 170. The MPEG-1 signal may also be stored via tape recorder 180 or DVDR/CDR recorder 182, or, as shown in FIG. 4, stored via a VIE recorder 460.

The removable media on which the MPEG signal is recorded is transferred to sled bay 154 by inserting it into one of removable drives 149 at the end of a patrol car shift or as required by operational policy. The data on the media is then processed by server 157. As discussed in more detail below, via a software program stored in memory 162, the instructions of which are processed by processor 158, the data is buffered in hard drives 159, depacketized, and decoded by MPEG decoders 163 into audio and video signals. The video signals are applied to monitor 172 to view the video while the audio signals are applied to speakers 178 and 179. Often, the decoded signals are also stored in some form. For example, utilizing computer 170, a user may select a certain portion of the recorded tape as being particularly relevant in a particular court matter. This portion may be depacketized and the MPEG data may be burned into a DVD disk via DVDR recorder 182. This disk may then be taken to court as evidence, without the need to have the entire command center 104 in court. The depacketized and decoded audio and video signals maybe stored by recording on tape via VHS recorder 180. However, since the VHS tape would not include authentication information (see below), such VHS tapes would generally be used for training purposes only.

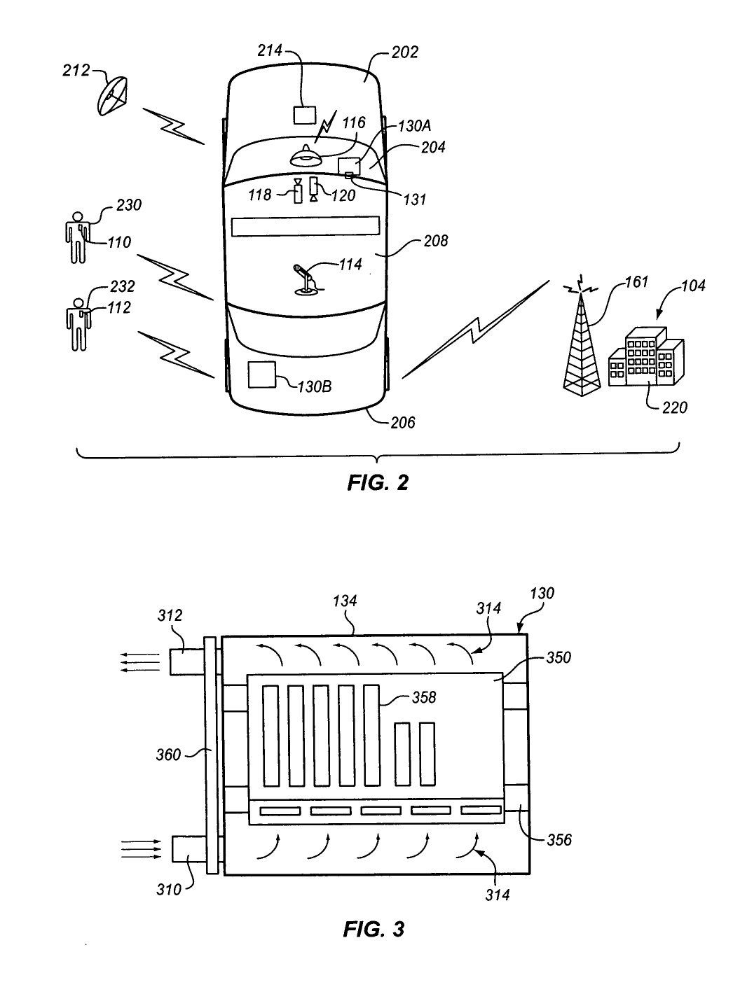

FIG. 2 is a schematic diagram showing the preferred locations of the audio and sound sources and the electronics box 130A or 130B with respect to patrol car 202 and officers 230 and 232. Electronics box 130A is preferably located in the police car dash, and includes a removable tape, hard drive, or solid state memory 131 that is accessible on the dash. It also is may located in the trunk 206 of patrol car 202, such as at 130B, or may be located under a seat or elsewhere. First video source 118 is preferably a high-resolution miniature video camera located just above the rear view mirror, and its lens is directed forward through the windshield 204 of the patrol car 202. Second video source 120 is preferably a high-resolution miniature video camera located next to the first video source, but is directed rearward and includes a wide angle lens to capture everything that occurs inside the passenger compartment 208. First audio source 110 preferably is a microphone, preferably located on a first officer 230. Second audio source 112 preferably is a microphone, preferably located on a second officer 232. Third audio source 114 is preferably a directional microphone located in a hidden position near the rear of the passenger compartment 208. The directional characteristics are selected to capture audio anywhere in the passenger compartment 208. Fourth audio source 116 is preferably a microphone associated with the two-way radio in the patrol car so as to capture the communications with the dispatcher. As known in the art, GPS satellite 212 is preferably located in stationary orbit of the earth. The headquarters 220 maybe located anywhere that has access to a wireless signal via antenna 161.

FIG. 3 shows the interior of electronics box 130, which maybe 130A or 130B. The electronic components 132, 136, 138, 141, 142, 143, 144, 146, 147, 148 (FIG. 1) are mounted on one or more circuit boards 350 that are suspended on flexible shock absorber supports 356 attached to housing 134. Note that the components are only shown generally on board 350; thus, the various elements, such as 358, are not meant to illustrate specific components in specific places. The box 130 maybe vented via a fan with cooling air entering at entrance port 310 and exiting at exit port 312, or may be a non-fan system using heat dissipation fins only. Ports 310 and 312 are preferably coupled to the outside air. Ports 310 and 312 are coupled to enclosure 134 via a flexible strain relief 360 to reduce jarring of the electronics by forces exerted on the ports. The cooling air follows a path shown by arrows 314. Enclosure 134 preferably has a volume of less than 0.15 meters cubed, more preferably 0.1 cubic meters or less, and most preferably 0.03 cubic meters or less.

In one embodiment, the tape drives 144, 151, 153, etc., are Sony AIT tapes, which are described in detail below, or may be an ADR™ tape drive manufactured by OnStream Data B.V., based in the U.S. and the Netherlands. These tapes utilize a completely enclosed cartridge. Several features of the preferred tape drive relevant to the invention are that the tape moves in a serpentine manner, the index is essentially in the middle of the tape, and the tape speed varies with the rate at which data is arriving. The index in the middle of the tape increases the speed at which the index can be written to and read. The variable tape speed allows the density of data on the tape to be maximized. For example, when the video is essentially static and little data is being generated, the tape slows down so that this little data is not spread over an unnecessarily large length of tape. This tape drive has rapid seek speeds, exceptional transfer rates, data reliability, and maximized media life. A single tape can store 60 gigabytes in the preferred mode, and up to 120 gigabytes if necessary. The ADR™ tape system has a 10¹⁹ bit error rate.

Turning to FIG. 4, a graphical representation of the synchronization capabilities of the surveillance system 100 according to the invention is shown. In this illustration, four MPEG channels are synchronized and monitored simultaneously on monitor 170. The essential elements illustrated are digital removable drives 151, 153, 155, and 156, the hard drive buffers 159, MPEG-1 channel selector 538, MPEG decoders 430, 432, 434, and 436, monitor 170, speakers 178 and 179, antenna 161, NMPEG-1 monitor 166, NMPEG-1 decoder 165, and VHS recorder 460. A digital removable media recorded according to the invention is inserted into each of the four drives 151, 153, 155, and 156. In the preferred embodiment discussed above, from four tapes or other media, eight MPEG channels are available as follows: channel 410 carries the exterior video and the audio from the two officers in a first patrol car, channel 412 carries the interior video, the interior audio, and the dispatch audio from the first patrol car, channel 414 carries the exterior video and the audio from the two officers in a second patrol car, channel 416 carries the interior video, the interior audio, and the dispatch audio from the second patrol car; channel 418 carries the exterior video and the audio from the two officers in a third patrol car, channel 420 carries the interior video, the interior audio, and the dispatch audio from the third patrol car, channel 422 carries the exterior video and the audio from the two officers in a fourth patrol car, and channel 424 carries the interior video, the interior audio, and the dispatch audio from the fourth patrol car. Any four of these eight MPEG channels maybe fed to any one of MPEG decoders 430, 432, 434, and 436. The video from the selected channels is synchronized so that frames shot at the same time are simultaneously viewed on monitor 170. Another feature of the software is that the time and location of an event can be entered and the system will search for this time and location and display it. The time and location maybe displayed with the event. Further, the video can be advanced and monitored frame-by-frame. Thus, if each of four patrol cars were at an event, synchronized videos 452, 454, 456, and 458 of the event shot from four different perspectives maybe viewed simultaneously either in actual motion, slow motion, or frame-by-frame. From such simultaneous monitoring, dynamic analysis of the event, such as echo ranging, audio forensics, and weapon determination, can be quickly and accurately performed. Similarly, selected pairs of the eight audio tracks available may be simultaneously played on speakers 178 and 179. Similarly, if a plurality of cars is at an event, one of the plurality of MPEG-1 videos available may be selected via selector 438 and monitored on MPEG-1 monitor 166. Alternatively, a selected MPEG-1 channel maybe decoded and recorded on VHS recorder 460. For example, this MPEG-1 channel could be a real-time video of the same location at which the scenes 452, 454, 456, and 458 were shot. The foregoing is not intended to be exhaustive of the possible uses of the system according to the invention; and, in fact, a myriad of different applications are possible. Rather, the above scenarios have been presented as examples of the use of the system 100 to better illustrate its operation.

As discussed above, the MPEG encoding and coding used in the invention are standard processes known in the art, and thus they will not be described in detail herein. A detailed description of the MPEG systems and processes is contained in “An introduction to MPEG video compression”, by John Wiseman; “Coding of Moving Pictures and Associated Audio for Digital Storage Media at up to about 1.5 Mbit/s”, ISO/IEC11172-2: Video (November 1991); and “Generic Coding of Moving Pictures and Associated Audio Information: Video”, ISO/IEC13818-2 Draft International Standard November 1994), all of which are hereby incorporated by reference to the same extent as though fully disclosed herein. However, the packetizing of the encoded MPEG data and the arrangement of the packets in the data stream provided by the invention are novel. An illustration of an audio/visual data stream 501 as it can appear on a tape 199 according to the invention is shown in FIG. 5. FIG. 5 shows two portions 502 and 503 of a single data stream 501. Portion 503 is a continuation of portion 502, though there is a substantial portion between the two portions 502 and 503 that is not shown, as indicated by the dots. The two portions are shown on separate lines because of the width limitations of the USPTO drawing page. As discussed above, two MPEG channels, preferably MPEG-2, are encoded from a single patrol car. The data from the first MPEG-2 channel is carried in packets, which in FIG. 5 are designated as VA, while the data from the second MPEG-2 channel is carried in packets designated as VB. Each MPEG-2 channel includes a video channel and two audio channels. In the preferred embodiment, the exterior video photographed through the windshield of the patrol car is combined with the audio from the two officers for one channel, and the video of the interior of the car is combined with the audio from the interior of the car and the dispatcher. This is the preferred arrangement because in many events the police officers are outside the car, and, of course, the dispatcher and internal car audio are more likely to correlate with the interior video of the car. However, other combinations are also possible. In addition to the MPEG-2 channels, the data stream 501 also includes data packets which contain digital data that generally is neither audio nor visual, which packets are designated with a “D”. The packets D preferably contain specific types of information at specific locations; for example, geographic information maybe located at a first location 560, information relating to if and when the officer removes the patrol shotgun from its cradle and when it is returned at a location 561, radar information, such as recorded speeds, at a location 562, and any other information of interest to the user at location 563. More or less data locations maybe in the packet D. In the preferred embodiment of the invention, a packet D is generated every five seconds, though other periods may be used, or other criterion for when a data packet D is generated may be used. Finally, the tape includes tracking information that is recorded at a QFA (Quick Find and Access) location 530. Preferably, the QFA location is at or near the center of the tape. This data includes year data 531, month data 532, day data 533, an MD5 hash value 534, as well as other data 535. As will be discussed in more detail below, to enable a quick find function, the tracking information is preferably stored in a buffer and is recorded on the tape just before it is removed. In addition, all the information in the D packet and the QFA is recorded in a header associated with each packet. One such header 515 having data locations 516A through 516H is shown for the VA packet 504. Every VA and VB packet has a similar header. Alternatively, this data is stored in a GOP (Group of Pictures) header extension user data field. The fact that the data is also stored in the headers permits the D data and the QFA directory data to be reconstructed in case of a sudden power failure or other failure of the system that corrupts the D or QFA information. The system 100 according to the invention provides a utility that performs this reconstruction process.

The audio/visual packets VA and VB preferably are of variable length, depending on the complexity of the information being captured. For example, if the scene being photographed is rapidly changing, the packets will be longer, and if the scene being photographed is static, the packets will be short. In the preferred embodiment of the invention, the longest packets are 32 kb-20 bytes and the shortest packets are 21 bytes. The packets are created and placed in the stream by a protocol that depends on the amount of data in a buffer and other efficiency factors. Those skilled in the art of communication buffers will be able to create appropriate packets; thus, the details of this protocol shall not be discussed herein. Many different such protocols may be used. In the portions of the data stream shown in FIG. 5, the data stream includes three VA packets beginning with packet 504, four VB packets beginning with packet 506, three VA packets beginning with packet 516, two VB packets beginning with packet 520, four VA packets beginning with packet 521, and two VB packets beginning with packet 526. There are also two D packets 510 and 512, one being inserted just before packet 514 and the other after packet 526. Packet 524 was not placed sequentially after the other VB packets in the 521 series because the tape is partitioned to reserve-the location 530 for the QFA data.

FIG. 6 is a schematic diagram 600 showing the primary software components of the preferred embodiment of the invention and the relationships between the software and hardware components in the preferred embodiment. In the preferred embodiment, the software of the invention is made to run on a Windows™ operating system. As known in the art, the state-of-the-art Windows™ operating systems include a kernal mode 602 and a user mode 604. Physical devices 606, such as tape drives, are connected into the Windows™ system via a hardware abstraction layer (HAL) 624. In addition to the HAL 624, the kemal mode includes a system services layer 620. Between the system services layer and the HAL layer, a Windows™ Executive system 602 operates. Windows™ Executive System 602 includes an object manager 626, a virtual memory manager 628, an I/O manager 630, a cache manager 630, and a process manager 634. The system services layer communicates with the HAL layer via device class drivers 636, which are part of the Windows™ system and specific mini-port drivers 612 provided by the manufacturers of the physical devices, which integrate into the device class drivers as indicated by the notch 637. The system services layer 620 and the user mode applications above it communicate with the device drivers via unique file system software 610 which forms an important part of the invention and will be described below. As known in the art, the user mode 604 includes a Windows™ security system 640, a Win32 subsystem 642, as well as other subsystems 644. Client threads, also known as applications, such as 650, 652, 654, and 656, communicate with the kemal mode through one of the subsystems, depending on the functions they implement. As will be seen below, the encoder and decoder systems are specific client threads.

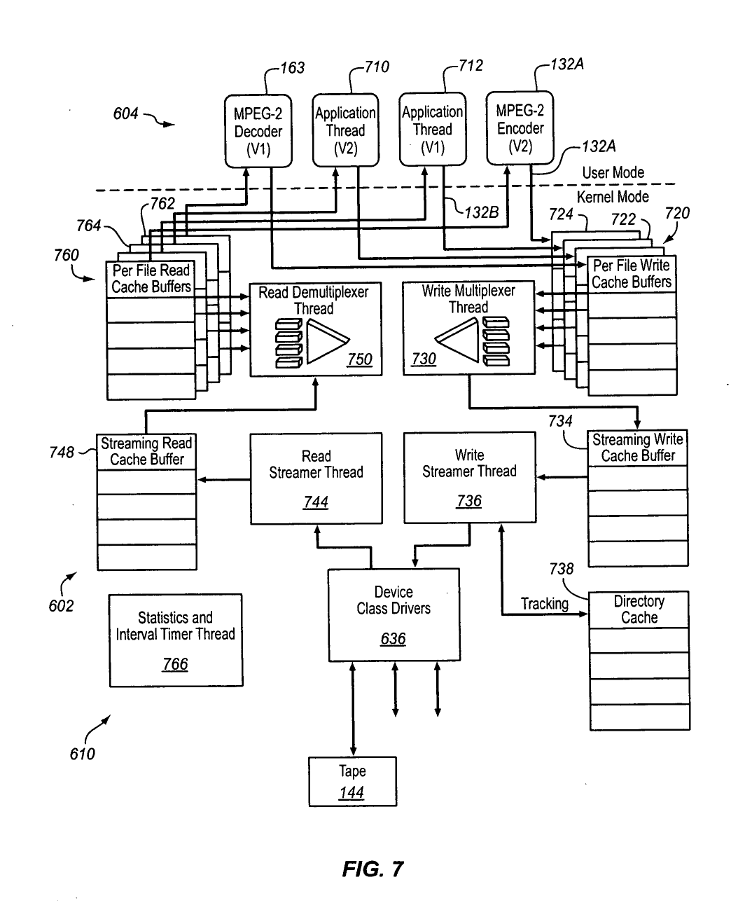

The inventive file system 610 and how it operates the hardware described above is illustrated in FIG. 7. The right side of FIG. 7 describes the file system as it operates in the electronics box 130 of the patrol car, while the left side describes the file system as it operates in the command center 104. As suggested above, the file system 610 accepts data from the application threads 159, 710, 712, and 132, which are specific instances of the client threads of FIG. 6, processes the data, and delivers it to the device class drivers 636, which deliver it to the physical devices. The physical device of most interest herein is the tape drive 144 within the patrol car 202. The specific application threads of interest are the MPEG-2 encoder 132 channels 132A and 132B and the MPEG decoder channels such as 410 and 412 (FIG. 4). As discussed above, in the preferred embodiment of the invention, there are two MPEG channels 132A and 132B from encoder card 132. In FIG. 7, one of the threads is labeled 132. However, the other thread is labeled generally as an application thread 712. The threads are also labeled V1 and V2 to indicate which video source is involved, though it should be understood that audio sources are also included Likewise, there are two MPEG decoder channels in the preferred embodiment of the invention, but one is labeled generally as an application thread. This has been done to emphasize the fact that the file system 610 according to the invention has many applications other than serving to organize and direct MPEG data. That is, the patrol car application discussed herein is only one example of the use of the file system 610. In the discussion of the operation of the file system 610 to follow, the functions of the various software elements of FIG. 6 will not be discussed in detail since these are well known in the art. However, it will be understood by those knowledgeable about the Windows™ operating system that many of these elements assist in the operations described.

In the file system 610 according to the invention, the data generated by application threads 712 and 132, which in the application herein are encoded MPEG audio/video channels, is directed to per file write cache buffers 720. Each application thread, that is, each MPEG channel, is directed to a different buffer. The V1 channel is directed to buffer 724 and the V2 channel is directed to buffer 726. In the embodiment shown, there can be up to four application threads, as four buffers are shown; however, more than four application threads and more than four per file write cache buffers may be used. The data in the buffers 720 is organized into VA, VB, and D packets and interleaved into a data stream 501 by write multiplexer thread 730. The data stream is directed to streaming write cache buffer 734. The purpose of streaming write cache buffer 734 is to eliminate any differences between the flow of the data stream and the operation of tape 144, which differences can arise in the mechanical operations of the tape drive. For example, the tape must pause in accepting data when it reaches the end of the tape and reverses. During this time, the streaming write cache buffer will collect and hold the streaming data. The write streamer thread 736 forms the final streamer thread and directs it to driver 636, which delivers it to tape 144. The data stream is parsed continually in write streamer thread and tracking data, such as the location of GOP (Group of Pictures) headers, and year/month/day information is stored in directory cache 738.

In another embodiment of the invention, the MPEG GOP headers are modified to add the geographic and year/month/day information. Other digital information also maybe added to the GOP headers. In this embodiment, the decode system software is modified to read this information. In another embodiment, this data is periodically added to the MPEG-1 stream with a marker to permit it to be easily found. This information is preferably displayed directly on the screen on the monitor with the video, although this feature can be turned off.

Content verification of the video, audio, and GPS data is done via computation of an MD5 Message Digits 5) hash on the data streams as they are output from the hardware encoding devices. To insure that encoded data is not modified and re-hashed, an administratively designated non-retrievable pass-code is assigned to each Mobile Unit before it enters the field. The resultant hash codes, a combination of data and pass-code, is stored with the directory data and can be used to tell if any of the data streams have been modified. MD5 hash codes (128-bits) are computed over video GOP (Group of Pictures) intervals; i.e., they are constructed from all video, audio, and PS encapsulation data between GOP headers. This process is not an encryption or watermarking scheme. The message digest function is also sometimes referred to as a one-way hash function.

The MD5 hash function is a one-way algorithmic operation that transforms a string of data of any length into a shorter fixed-length value, usually 128 bits or 16 bytes long. The algorithm is coded in such a way that there is a negligible probability that any two strings of data will produce the same hash value. If just a single piece of data is changed, a different hash value results. At anytime, data integrity can be checked by running a utility verification program supplying the original pass-code, which program is generally referred to as a checksum procedure. That is, the data integrity can be verified by running a hash operation on the data and the private pass-code, i.e., the one assigned to the patrol car when it enters the field. The resultant hash value is compared to the hash value stored in the data. If the two values match, that data has not been altered, tampered with, or modified in any way, and the integrity of the data can be trusted. This comports with the “best evidence rule” and authentication requirements used by courts. The MD5 algorithm is a well-known standardized algorithm Thus, it will not be further discussed herein. It is generally believed that it is computationally infeasible to duplicate an MD5 message, or to produce any pre-specified MD5 message.

Just before the tape is removed, the information from directory cache 738 is written to the QFA portion of tape 199.

The operation of file system 610 in command center unit 104 is the reverse of its operation in the patrol car. The data stream is read out of the tape drive via the device class drivers 636 and delivered to the read streamer thread 744. The read streamer thread 744 directs it to streaming read cache buffer 748, which smoothes out any discrepancies between the flow of data and the mechanical operation of the tape drive 144. The data stream is demultiplexed by read demultiplexer thread 750, and the data associated with each application thread is cached in the appropriate one of per file read cache buffers 760. Namely, the data from the V1 MPEG channel is cached in buffer 762 and the data from the V2 channel is cached in buffer 764. The buffers then stream the data to the corresponding application thread, which in the exemplary embodiment is the corresponding decoder 163 or 710. Those skilled in the art will recognize that the hard disks 146, together with the microprocessors 142, under software control, act as the buffers and multiplexers of the patrol car side, while the hard disks 159 and microprocessor 158, under software control, serve as the buffers and demultiplexer of the command center side. These buffering and multiplexing functions are well understood in the computer art and, therefore, will not be described in detail herein. The file system 610 also includes statistics and interval time thread 766. Thread 766 provides a set of private I/O Control (IOCTL) codes that allow an application program to set options and gather statistics on file system performance. The statistics gathered can be used to tune cache buffer sizes and optimize aspects of the read/write streaming algorithms.

The streaming write capabilities of sequential access devices dictate that write operations always be performed at the current End-of-Data location. This knowledge forms the basis of the above-described two-stage write cache architecture. Write caching is done on a per-file basis to decouple slow sequential device access times from the application thread requesting the synchronous write operation. For synchronous writes, the application thread is blocked only until write data has been queued to the write cache buffers. The write queue is serviced by an internal worker thread that is directed by a multiplexing algorithm, which places its results into the device's multiplexed-write queue. The multiplexed-write queue is serviced by an internal worker thread that is directed by a streaming algorithm optimized for device write streaming. To mitigate paging area contention, internal cache areas are backed by temporary files on disk-based file systems, preferably on non-paging NTFS drives. Data from multiple file write sessions is multiplexed at the media block level such that the average data rate for a given file is maintained over time.

The streaming read capabilities of sequential access devices permit random read access. Because of this capability, and the need to permit multiple simultaneous reads, the read cache process is not an exact mirror of the write cache process. Read data is read-ahead streamed off the device and placed into the multiplexed-read queue. When a specific file is opened, its data is broken out from the multiplexed-read queue into its own read cache buffers. The read cache buffers and the multiplexed- read queue are filled by a special algorithm optimized to give increased read performance priority to files that were opened first.

The system 100 uses a TCP mediated distributed architecture providing flexible scalability through the addition of modular components. This network-based approach uses TCP/IP point-to-point connections for commands that don't require synchronization (i.e., configuration and monitoring). For synchronized activities, a UDP connectionless protocol is used to broadcast commands providing more accurately synchronized record/play/stop/pause functionality across the distributed architecture.

A feature of the invention is that sequential write performance is equivalent to that of writing to a physical disk drive. Read performance is based on a number of factors. If the files being read were written at the same time, i.e., their blocks were multiplexed close together, then read performance is equivalent to that of reading from a physical disk drive if the average aggregate read data rate is not greater that of the underlying sequential access device. If aggressive head movement or volume exchange is required to obtain their data blocks, then read threads are delayed until such data can be located.

Other details of the system 100 are as follows. Since the geographic information is available via the MPEG-1 stream as discussed above, this information can be used to locate the patrol car in an emergency. It is also evident that the invention can be used to construct all-points news bulletins, notification to other departments, and has many applications for training purposes. The system 100 includes electronic circuitry, software, and processes to provide remote power-on/boot and power-off from the patrol car dashboard, full cycle boot at power up without user intervention, vehicle ignition-controlled start and shutdown, programmable shutdown, battery fed continuous operation after ignition shut down, vehicle speed, direction, and location integration via the GPS information, out-of area and failure notification, and status of storage available indication. System status lights and failure lights are dashboard mounted. The central command center features include: on-demand wireless communications with mobile units for audio and video “real-time” viewing, post-event playback and review capabilities, multiple unit synchronization, full VTR controls with added search capabilities, and post-production capabilities. Existing MDT, CDMA, or cellular technologies can be incorporated for the wireless transport of the MPEG-1 signal, geographic and time data, patrol unit and shift, and other significant information. Built-in diagnostics monitor video encoder status, battery condition, power supply output, system operating temperature, and many more system conditions. The command server 157 has been designed using a single board computer (SBC) with the Coppermine™ 700 MHz Pentium III Processor, and up to 512 MB of Random Access Memory (RAM). The SBC is designed to be a functioning “mini” computer built onto a PCI card. In the event of a failure of the board, CPU, or RAM, the card is simply replaced without dismantling the entire system. As indicated above, the command server can be equipped with CD-ROM recorders, DVD recorders, or digital tape recorders for long-term archival depending on client needs. The Raid system 159 is preferably a RAID 01 system with mirrored hard drives. The cameras are high-resolution color for normal light IR with monochrome imaging for low or no light situations. They both have wide-angle camera lenses and include a composite video splitter, i.e., two inputs to one composite output. The front facing color camera 118 features a ½-inch CCD capable of capturing an NTSC image with 480 lines of horizontal resolution. The minimum illumination is 1.0 Lux through an auto iris F/1.2 lens. The rear facing wide-angle color camera 120 features a ¼-inch CCD capable of capturing an NTSC image with 350 lines of horizontal resolution. The minimum illumination is 2.0 Lux through an F/2.0 lens. The interior microphone 114 is sensitive to 1V/Pa @ 1 kHz (−2.5 dBV +/−4 dBV) and has an output impedance of less than 150 Ohms. The voice input distance ranges from 7 cm to 1.5 m to accurately capture all audio within the seating area of the patrol car.

The system includes automatic file naming with unit number, date, time, and shift, which is included in the QFA section.

A feature of the invention is that the streaming tape recorder capable of a data rate equal to or greater than the aggregate recording rate permits VCR-like functionality in a digital tape recorder of much higher resolution.

Current mobile surveillance systems record to analog VHS tapes or camcorders. The problem with analog VHS tapes is that the video quality is poor and most tapes record for only a couple of hours. Some manufacturers claim much longer recording times of up to eight hours, but those are typically at very slow frame rates of recording, making for jerky movements and poor image quality. A feature of the invention is that DVD-quality video results. Additionally, digital tapes can be reused for 30,000 cycles and the shelf life for digital tapes with no degradation in quality approaches thirty years as compared to 30 cycles and one to five years for analog tapes.

It is a feature of the invention that the data is streamed to digital tape in real time. Except in cases where the tape is changing direction or some similar event, the data is processed immediately and passed to the tape, rather than being stored for a significant time, for example, for a time greater than normal computer processing time, and then processed later. Real time also means that, from the perspective of a human being, the transfer to tape usually would appear to be instantaneous. A related feature is that, in the system of the invention, the digital recorder and digital tape comprise the primary storage system rather than a backup storage system.

It is another feature of the invention that the system 100 captures full-motion video. Full-motion video is any video that captures at least 24 frames per second and more preferably at least 29 frames per second. As known in the art, the full-motion video NTSC standard is 29.97 frames per second. A related feature of the invention is that the system 100 at the same time captures full-frame video, which means any resolution of at least 720×480 pixels. A further related feature of the invention is that the system 100 can capture at least eight hours of full-motion, full-frame video on a single digital tape. A further related feature of the invention is that the system 100 can capture at least eight hours of two full-motion, full-frame videos on a single digital tape.

A further feature of the invention is that each data packet, such as 504, is independent. By “independent”, it is meant that at least a portion of the audio and at least a portion of a video frame can be reconstructed from a single packet. In the prior art, if a system were downloading a video file and the process was interrupted before it was completed, the result would be unintelligible. However, in the system 100 according to the invention, the packetization system and process results in a single packet being intelligible. Of course, the more packets that are received, the more of the sound and video can be constructed. Thus, if only a portion of a tape is available, say due to a fire or other catastrophe, useful information can still be obtained from the tape.

Another feature of the invention is that the mobile system 102 is designed for use in a dynamically changing environment. The basic unit operates in temperatures in excess of −25° C. to 81.1° C. with an optional electric temperature controlled environment. Depending on configuration, operating temperatures required for the power supply are −25° C. to 81.1° C. or −40° C. to 80° C.

The above describes a novel vehicular surveillance system that permits a full shift of two MPEG channels of full-frame, full-motion audio/video to be captured on a single cartridge tape. The system for the first time permits 24/7 patrol car surveillance at high resolution. Now that the system has been created and disclosed for use in patrol cars, it is evident it will have applications in many situations in which a compact, high-resolution surveillance system is desirable. For example, it will have applications in airplanes, trains, ships, and other vehicles. Thus, wherever the terms “patrol car” or “police car” have been used above, any other vehicle may be substituted. It also will find use in many security applications. It is believed that the invention will make digital tape cartridges a preferred primary storage device. Examples of such applications are as follows. The system of the invention could be used in a manufacturing facility, such as an automotive assembly line or an integrated circuit manufacturing facility for quality control purposes. In such manufacturing processes, defects often occur that are difficult to find the reason for. Since it usually is known when the particular vehicle or part was manufactured, a library of 24/7/365 tapes would be useful in tracing and correcting defective processes or systems. Another example is any test operation, such as the test of a jet fighter or the destructive test of a system. Since it is often not known when the object being tested will deviate from specification, a 24/7/365 surveillance system would be useful. The system can also be useful in an operating room to record an operation from many different angles for instruction or legal purposes. It may also be used in stores, government and public buildings, and anywhere else that surveillance systems are in use today.

The surveillance system 100 according to the invention was developed to provide an improved patrol car surveillance system. To achieve this goal, many novel components had to be developed. Now that the system has been built, it is evident that many of these elements will have important uses in other applications. For example, the file system 610 according to the invention that streams data to digital tape will be useful in many instances in which rapid streaming of sequential time and/or geographic synchronized data is desired. For example, it is useful in database logging, ISP logging, transaction logging, firewall logging, backups, general audio/video encoding, and data acquisition.

A feature of the file system 610 is its ability to multiplex data from several streams into one bundled stream that is then stored on and retrievable from the tape drive. Another feature of the file systems 610 is the ability to access the tape drive from a PC as a local drive letter or as a Universal Naming Convention (UNC) mapping across a network. In addition, the relative cost of tape drives and their media is less, on a per gigabyte basis, than the cost of hard drives. These features move the tape drive from its traditional position as a data backup product to that of a primary storage medium for many applications. The types of applications that are particularly targeted are: (i) those in which the data does not need to be accessed often; (ii) those in which data does not need to be written onto the tape and accessed at the same time; and (iii) any of the foregoing applications that would benefit from a removable medium.

The principles of the present invention represent a paradigm shift with respect to patrol car surveillance systems. The prior art patrol car surveillance systems were seen as tools to be subjectively used by police officers. The principles of the present invention view surveillance systems as being objective tools of administrators, prosecutors, and courts.

In addition, the principles of the present invention advance the art by overcoming conventional surveillance system problems by recognizing that the way to avoid having evidentiary gaps in the audio/visual record is to have high resolution audio/visual recording operating at all times that a police car is on patrol, 24 hours a day, 7 days a week, 365 days a year. With the prior art video systems, this would immediately lead to data overload. However, as described herein, the above requirement does not mean that the audio/visual system has to be able to store scores of hours or days of data in the vehicle, because patrol officers always work in shifts that generally are of from 8 to 12 hours in length. If changing the data medium is made simple enough, it can become a routine part of the shift change, and operate repeatedly and reliably.

While the replaceable hard drives that have become part of most surveillance systems today are advertised as being simple to use, in fact, few people can routinely and repeatedly perform the change and/or perform a downloading operation without incident. Further, the fragility of hard drives and the hazards of police work make the use of such drives problematic in the patrol car environment. Changing a tape cartridge is something that most people today can do repeatedly and reliably. Further, tape cartridges are rugged and tape data is rarely inadvertently destroyed. In accordance with the principles of the present invention, an audio/visual surveillance system records data and/or content to a tape cartridge within the vehicle. In one embodiment, the tape is digital tape. This provides an essentially fail-safe system in which data is reliably and routinely transferred to a central storage system at the end of each shift. The system includes a cartridge tape storage sled bay at the police headquarters or other facility to which officers return at the end of a shift. At the beginning of the shift, each officer is provided a tape cartridge, which they insert in the recorder in their patrol car. At the end of each shift, the officer simply removes the tape cartridge from the patrol car and inserts it in the tape storage sled. The rest is automatic.

The MPEG-2 video/audio compression standard is well known in the movie and video art, though it is usually associated with DVD systems. The MPEG-2 standard provides the high-resolution, dense storage associated with home DVD systems. The system and process permits the direct recording of MPEG-2 audio/visual data to a cartridge tape in a patrol car. Further, with the development of MPEG-4, this and other compression techniques may alternatively be utilized for surveillance systems in accordance with the principles of the present invention. In this disclosure, any reference to MPEG-4 includes H264, MPEG-4/H.264, MPEG-4 Part 10, H.264/AVC, or any other designation that is associated with this standard, as well as any other part of MPEG-4.

The system also provides for wireless transmission of audio/video directly from the patrol car to the central command center or headquarters. Since wireless transmission does not presently have a broad enough bandwidth to support real time streaming of MPEG-2 audio/visual, the system also provides for MPEG-1 encoding of an audio/visual signal, which MPEG-1 encoded signal is buffered, preferably in a RAM or hard drive, and then may be transmitted on command. Preferably, the MPEG-1 encoding and wireless transmission can be initiated from either the patrol car or from the central command center via a wireless link

The system also provides an arrangement of audio and video sources that is designed to capture most, if not all, events of interest. There may be two or more video sources, one of which captures events outside the patrol car and the other of which captures events inside the patrol car. There may be three or more audio sources, one of which captures audio inside the patrol car, another which is on one officer's person, and a third that captures the radio exchange with the dispatcher. If two officers are present, a fourth audio source may be on the second officer's person. One video signal and two of the audio signals are encoded in a first MPEG-2 channel, and the second video signal and the third and fourth audio signals are encoded on a second MPEG-2 channel.

The two MPEG-2 signals are buffered, formed into data packets, and multiplexed into a single data stream. The multiplexed data stream is preferably buffered to remove asynchronies between the tape movement and the incoming stream, and then is recorded on the tape.

MPEG-4, MPEG-2, and MPEG-1 contain time synchronization data. As known in the MPEG art, each frame contains synchronization information. Further, the synchronization data is keyed to a GOP (Group of Pictures) header that occurs regularly, for example every 15^{th} frame, in the MPEG data, or approximately every one-half second. This synchronization data time correlates the individual MPEG frames. Geographic location data and, preferably, absolute time data may be acquired via a satellite link or otherwise. Hour/minute/second data are automatically incorporated into the MPEG data as known in the MPEG art. The tape maybe parsed and the location of each GOP header is found. This GOP header location information and year/month/day data are cached in a buffer and recorded in a tracking location on the tape. Using the year/month/day data and the MPEG synchronization data, each frame can be accurately time referenced. The absolute time signal is used to periodically update the clock of the system computer. In this manner, each frame can be time referenced within a fraction of a second. The geographic data maybe recorded in a special digital frame that is recorded regularly on the tape, preferably every five seconds. This digital frame may also include information such as if and when the patrol car shotgun is removed from its rack, radar data, and any other special data that a user may desire. All of this data may also be recorded in a header to each data packet so that, in case of system failure, all the geographic and time data can be reconstructed.

Once the tape cartridge is inserted into the sled bay in the central command center or other location, the system, software, and method of the invention permit the audio/visual data to be easily retrieved, monitored, synchronized with other data, stored, and archived. This is facilitated by the fact that it is encoded via the MPEG-4 or MPEG-2 standard. The data on the tape may be transferred to a hard drive of a command server with a form of RAID data storage. If the data is to be monitored, multiple videos can be synchronized and viewed at the same time. In one embodiment, up to four videos can be viewed at the same time. For example, if four police units were at an event and recorded the event, the event can be viewed from four different angles. The data can also be decoded and transferred to any desired medium, for example, an analog tape or a DVD disk.

The system permits the tape hard drive cache system to be accessed as a universal naming convention (UNC) drive, which is most commonly implemented as a letter. That is, using conventional software programs, such as Windows™, the invention permits the tape hard drive cache system to be designated as the “D” drive, for example.

The MPEG-1 low-resolution data stream is also buffered in the central location on a hard drive of a server. It maybe decoded and monitored directly, or it maybe decoded and stored on any suitable medium, such as a VHS recorder. Via the tracking data, it may be synchronized with MPEG-1 data from other units, or at a later time, with MPEG-2 data in storage.

An authentication process that ensures that the recorded audio/visual evidence will be acceptable to the courts may also be utilized. In one embodiment, a private pass-code is assigned to each patrol car as it goes in the field. This pass-code is used to generate a verification code that is stored on the tape. This verification code can be used to authenticate the data at any time by running a verification procedure, preferably a checksum procedure.

Essentially, all audio/visual information associated with a patrol car maybe reliably captured, monitored, correlated, stored, retrieved, and authenticated in accordance with the principles of the present invention. For example, a common occurrence today is that a suspect or criminal will claim officer brutality and point to bruises as evidence of the charge. Often, however, the bruises are self-inflicted after the person has been confined within the back seat of the patrol car. Each such charge, even if false, usually costs the jurisdiction a significant amount of money, on the order of $25,000.00, in investigating the charge and prosecuting it, if necessary. The invention will go a long way toward reducing and/or eliminating such expenses.

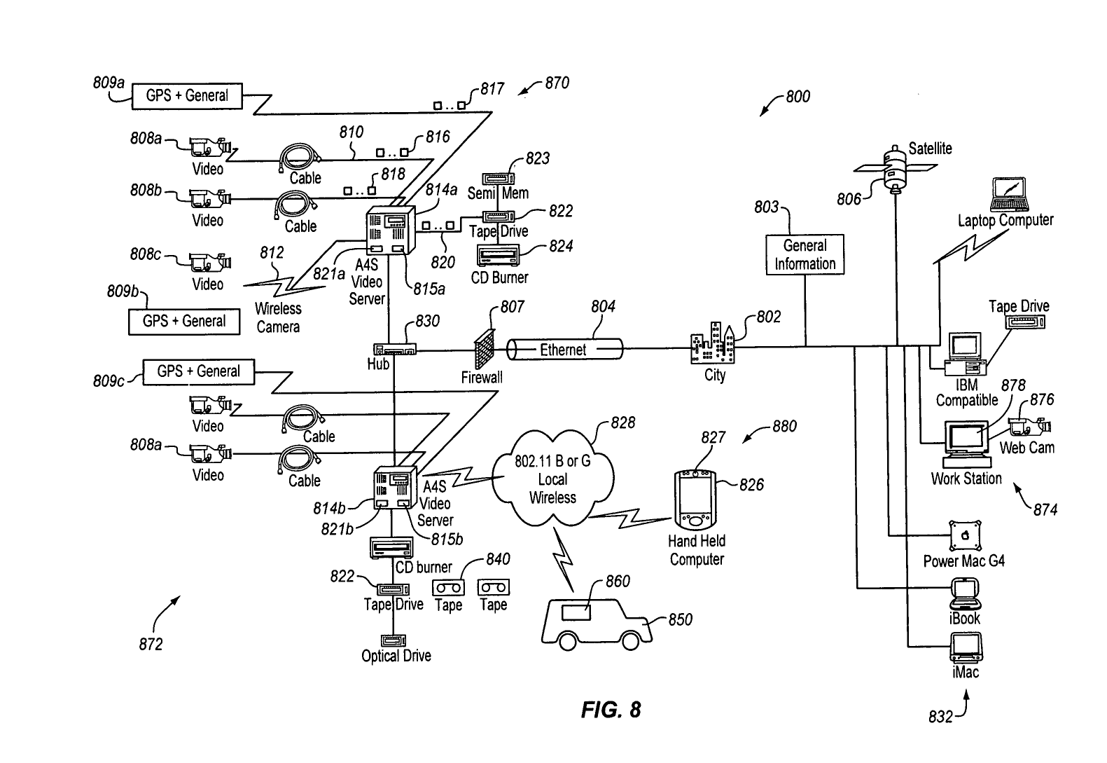

FIG. 8 is a diagram of an exemplary network 800 in which one or more surveillance systems in accordance with the principles of the present invention is utilized. The network 800 maybe configured within a city 802 and be composed of one or more communication networks. The communication network 800 may include an Ethernet network 804, satellite network 806, a general information network 803 and/or any other wired, wireless, optical, or the like, network In these networks, a firewall 807 may be utilized to ensure that content communicated and stored on the network is uncompromised by any undesirable persons or machines. In FIG. 8, five different surveillance systems 860, 870, 872, 874 and 880 are integrated into network 800. Each of the surveillance systems 860, 870, 872, 874 and 880 may be independent or operate cooperatively with other portions of the network.

One or more video recorders 808a-808n (collectively 808), embodiments of the video sources 118 and 120, operate as surveillance devices. The video recorders 808 and GPS and general information devices 809a, 809b, and 809c (collectively, 909) maybe wired and connected via a physical cable, such as 810, or wireless and communicated across a wireless link 812. A video server 814a may receive video signals 816 and 818, for example, from video cameras 808a and 808b, respectively, and other signals 817 representative of general data, such as event information, as well as GPS data, to be compressed into a compressed video signal 820 (e.g., MPEG-4 video signal) and stored on a digital removable media, such as a tape drive 822, a semiconductor memory drive 823, or a removable hard drive, in accordance with the principles of the present invention. In addition, the compressed video signal 820 is preferably stored on a hard drive 815a in server 814a or other medium to either as a backup or as a primary storage device. A timing marker generator 821a, 821b is also included in servers 814a and 814b. The video recorders 808 may output the video signals as digital signals in a digital stream, packet format, or otherwise, or as an analog signal to be converted into a digital signal at the video server 814a or other controller (e.g., electronic box 130 of FIG. 1). A CD burner 824 may additionally be configured with the video server 814a or storage of the compressed video signal 820. As shown, in addition to video recorders 808 being in communication with video server 814b, a handheld computer 826 and/or other wireless devices having an integral camera 827 may communicate with the video server 814b over a wireless network 828, such as an 802.11b local area network (LAN). Similarly, a mobile surveillance system 860, which may be a system 102 as described in connection with FIG. 1, located in a vehicle 850 can communicate with network 800 via wireless or by physical transfer of tapes 840, as described more completely in connection with FIGS. 1-4. It should be understood that while using compression may be preferred for storage of the video content, uncompressed video alternatively may be utilized in accordance with the principles of the present invention.

A hub 830 may be integrated into the network 800 and be configured to enable users on the network to access content stored and maintained by the video servers 814a and 814b (collectively 814) accessible to the hub 830. As shown, there maybe a number of remotely located computers 832 configured to engage the network 800. In one embodiment, the network 800 is the Internet. The computers 832 may access anyone of the video servers 814 configured on the network as understood in the art. Accordingly, people operating the computers 832 may access content (e.g., surveillance content) that is stored on digital tapes or other media for review thereof in accordance with the principles of the present invention. Alternatively, a camera 876 and other surveillance devices may be connected to a computer or workstation 878 to provide a surveillance subsystem 874.

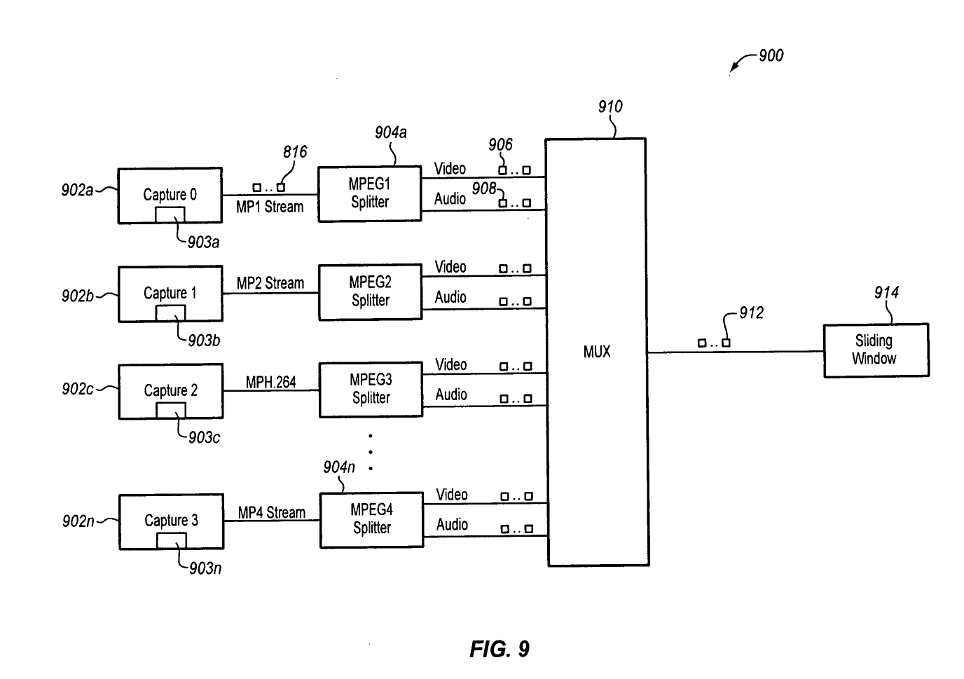

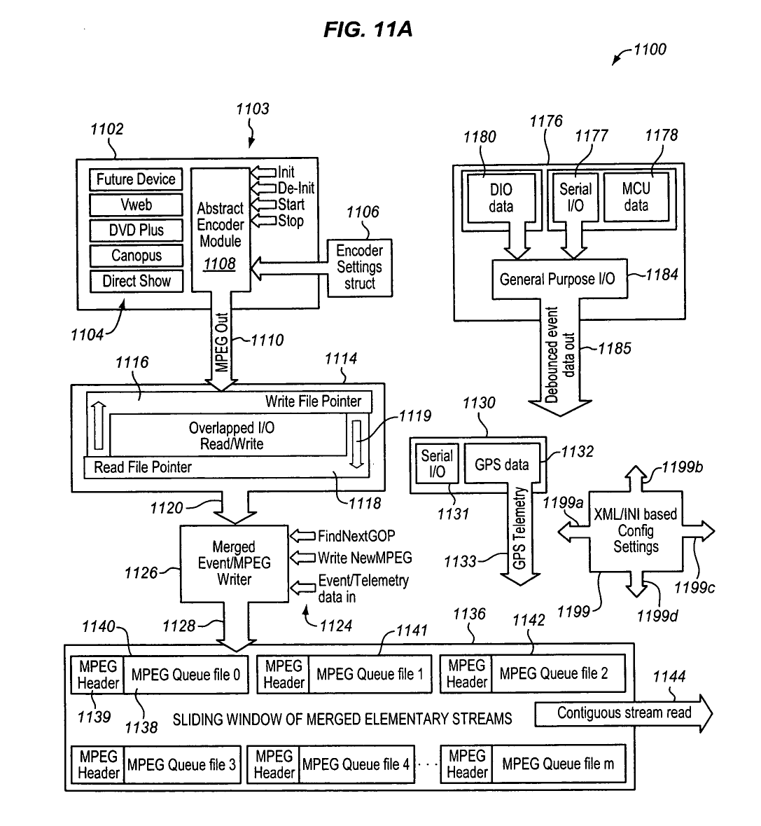

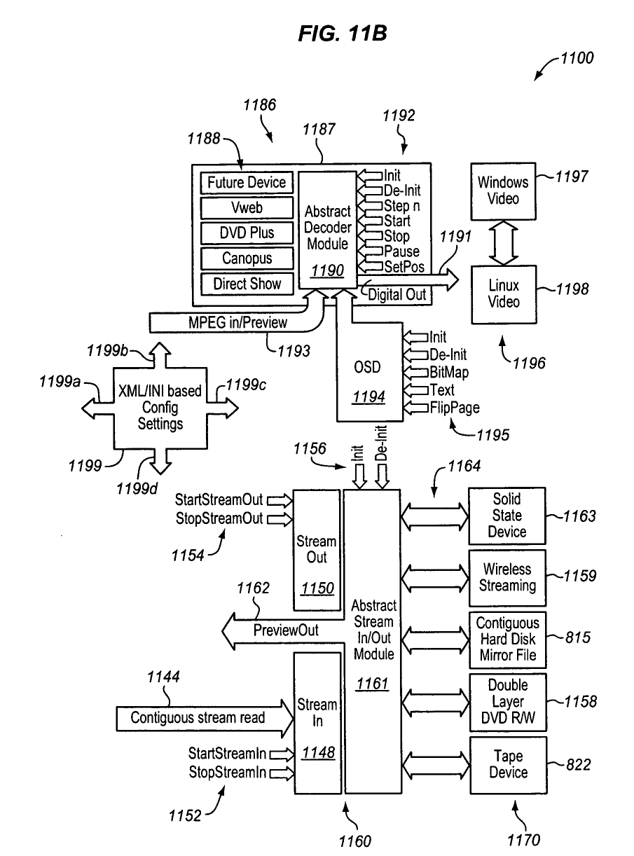

FIG. 9 is a schematic illustration of a portion 900 of a surveillance system, such as 860, 870, 872, 874 or 880 of FIG. 8, showing how the system captures a variety of video/audio streams and multiplexes them into a sliding window storage system. As shown, a plurality of video capture systems 902a-902n (collectively 902) may be utilized to generate, or receive and communicate, a digital video signal 816. In one embodiment, the digital video signal 816 is an MPEG video stream that includes video and audio signals. The capture systems 902 may be video the video cameras 808a, 808b etc. of FIG. 8, video recorders, or other similar devices configured to output the digital video signal 816, computer hardware, such as a processor, configured to receive a video signal and convert it to a particular format (e.g., MPEG-1, MPEG-2, MPEG-4, MPEGH.264 etc.), a buffer configured to receive and output the digital video signal 816, or other device as understood in the art. Each capture system 902a, 902b, 902c through 902n has a separate control system 903a, 903b, 903c through 903n, respectively. Splitters 904a-904n (collectively 904) are utilized to split the video and audio content from the digital video signals 816 into a video signal 906 and audio signal 908. As shown, the splitters 904 may be MPEG splitters, but any other compression system splitter may be used. In addition, each of the systems my have a different pixel density or resolution, such as conventional definition Of 210,000 pixel resolution or high definition of about 2,000,000 pixel resolution. As shown, each splitter is configured to communicate solely with a respective capture device. The separate capture, control, and splitter devices, which are also reflected in the separate encoders 1104 and decoders 1188 of FIGS. 11A and 11B, permit each video stream to have its own compression scheme, its own resolution or definition, its own transmission rate, as well as any other special parameter. The transmission rate can be controlled with controls 903a-903n, thus, for each channel (stream) the transmission rate is variable. It should be understood, however, that a single splitter maybe configured to handle one or more digital video signals 816 being generated from multiple video capture devices with the use of a switch, multiplexer, or other device to channel the digital video signals 816 from the particular capture device.

A multiplexer 910 is configured to receive the video signal 906 and audio signal 908 from each of the splitters 904 and form a multi-channel content stream 912 that includes the video signal 906 and audio signal 908. The multi-channel content stream 912 is input into a sliding window 914 for use in writing onto a medium, such as digital tape, a removable hard drive, or other media. The sliding window 914 may be a processor executing software configured to operate as a sliding window as understood in the art.

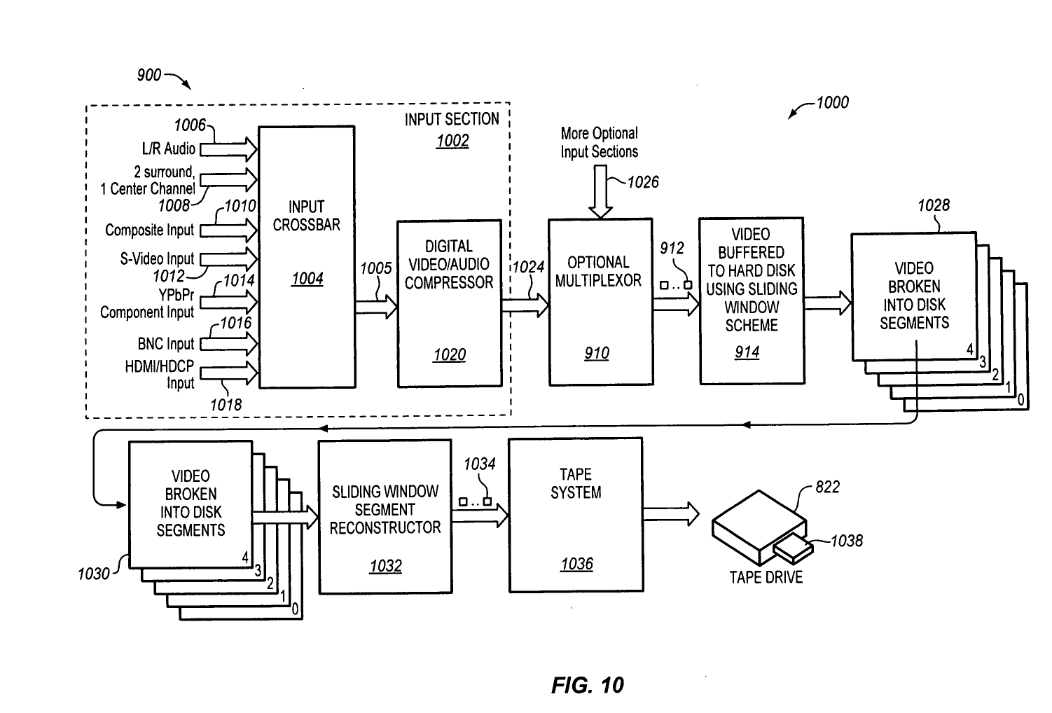

FIG. 10 is a high-level block diagram of the video flow in the preferred embodiment of the surveillance systems of FIG. 8. An input section 1002 may include an input crossbar 1004 that, in one embodiment, is configured to select and convert one of an analog or digital input into a pure digital frame, such as a YUV2 frame, as understood in the art, and receive one or more audio inputs. There may be a number of different inputs into the input crossbar 1004, including a left/right (L/R) audio input 1006, two surround—1 center channel input 1008, composite input 1010, S-video input 1012, YPbPr component input 1014, BNC input 1016, and HDM/HDCP input 1018, which are well understood in the art.

The input crossbar 1004 outputs a digital signal 1005 including YUV2 frames and audio signal to a digital video/audio compressor 1020. The digital video/audio compressor 1020 receives the digital frame and applies a compression scheme to reduce the data to a manageable size. The compression scheme may be any compression scheme utilized to compress digital video signals as understood in the art. The compressed video signal is output from the digital video/audio compressor to an optional multiplexer 910. The multiplexer 910 is configured to receive multiple video streams and combine them into a synchronized or multi-channel content stream 912. The multi-channel content stream 912 is buffered to a hard disk using a sliding window 914, where video segments are added to the back of previously stored video segments. The multi-channel content stream 912 is separated into disk segments at 1028. At 1030, the video stored onto the hard disk is read from the front. A sliding window segment reconstructor 1032 reconstructs the video and generates a video stream 1034, which is communicated to a tape system 1036. The tape system 1036 writes the incoming video stream 1034 to digital tape cassette 840 on the tape drive 822 (FIG. 8). This large buffering scheme allows for real-time video to continue without loss, even if the tape drive 822 slows while performing lengthy seek operations.

FIGS. 11A and 11B together show a diagram illustrating the data flow in an exemplary system 1100 according to the invention, which may be a portion of any of the surveillance systems 860, 870, 872, 874 and 880 of FIG. 8, or may include portions of several of these surveillance systems under network control. System 1100 includes a video/audio module 1102, a general data module 1176, a GPS data module 1130, a video/audio buffer 1114, a merged event/MPEG writer 1126, a merged video/audio/GPS/ general data buffer 1136, an input/output module 1160, recording media 1170, output system 1186, video display module 1196, and control module 1199.

Video/audio module 1102 includes encoders 1104, control electronics 1106, and abstract encoder module 1108. Abstract encoder module 1108 is designed to be compatible with all or nearly all off-the-shelve video encoders. Thus, many different video encoders, such as a direct show encoder, a canopus encoder, a DVD plus encoder, a Vweb encoder, a solid state encoder, or anyone of future encoders that become available maybe used with the system 1100. The customer can specify which encoder is preferred, and one or more of the encoders shown may be incorporated into a specific system. Control module 1106 permits the compression type, such as MPEG-1 through 4, to be set, either variable or constant bit rate to be set, and the specific bit rate, such as 750 K per second through 25 MEGS per second, to be set. Other video encoder parameters may also be set as known in the art. Input module 1102 also includes user activated inputs 1103, such as initialize, de-initialize, start and stop. The encoded signal is output to buffer 1114 at output 1110. Data input into buffer 1114 circulates in the buffer, is queued, and is output at 1120 as required to create the organized partitions described below.

At the same time as the video is being compressed and organized, the GPS and general data is being collected and organized in general data module 1176 and GPS data module 1130, respectively. General data module 1176 includes a digital input/output module 1180, a mission critical unit (MCU) 1178, and a serial input/output module 1177. Digital input/output module 1180 provides vehicle speed, vehicle direction, vehicle elevation, vehicle or camera identification, and other information as specified by the customer. MCU 1178 is also customer specific. It includes a one of more of a variety of relays and switches which develop a specified voltage in response to a specific triggering event, such as shotgun removed from cradle, acceleration of a vehicle that is indicative of a chase, movement of a vehicle as may be indicative of an explosion or an accident, and manual switches such as to indicate a traffic stop, a robbery in progress, or other mission specific data desired by the customer. Data from DIO module 1180 and the combination of serial input/output module and MCU module can include any other information useful for surveillance, law enforcement, emergency response, other application-specific information and other information associated with the video/audio being recorded. GPS data module 1130 includes a serial input/output unit 1131 and GPS data unit 1132. GPS latitude and longitude telemetry information is output at 1133.

Merged event/MPEG writer 1126 receives input from outputs 1185 and 1133, merges it with video data output at 1120, and feeds it to merged video/audio/GPS/ general data buffer 1136 under control of inputs 1124 which include Find Next Group of Pictures (GOP), Write New MPEG file, and Event/Telemetry Data In, the latter which is a signal indicating that non-video data, such as GPS data, event data or other general data associated with the particular GOP and MPEG file is available to place in buffer 1136. Buffer 1136 is preferably a hard disk or semiconductor storage, but it also may be any other suitable media. In buffer 1136, separate streams 1140, 1141 through 1142 are set up, with each stream corresponding to a particular camera 808a etc. or other video input device. Each stream includes an MPEG header, such as 1139, and MPEG queue files, such as 1138, are shown in FIGS. 11A and 11B. The MPEG headers include the MPEG information as known in the art as well as telemetry, roster and tape positioning information as discussed below. The buffer media 1136 will generally have less storage than a tape, and thus, will run out of storage space before the tape. When this happens, the system begins writing over the oldest data, thus, the buffer is in effect a sliding window. Data is read out from the buffer 1136 in a contiguous stream to streaming in/out module 1160, which streams data in and out of storage media 1170 via input/outputs 1164. Stream in/out module 1160 includes a streaming unit 1148, which streams data in from buffer output 1144 and stream-out unit 1150, which streams data out to preview output 1162 and decoder 1186. Stream-in unit 1148 and stream-out unit 1150 are specific to the particular media and customer. Module 1160 also includes an abstract streaming steam out module 1161, which is capable of interfacing with any of media 1170 and any stream-in and stream-out unit. Stream-in unit 1148, stream-out electronic unit 1150, and abstract stream-in stream-out module 1161 each are controlled through control signals 1152, 1154, and 1156, respectively. Storage media 1170 preferably includes a tape drive 822 and hard disk 815, but may also be a double layer DVD read/write system, a wireless streaming system 1159, or a solid state streaming device 1163. The data is read into and out of the storage media in a plurality of partitions, which will be described in detail below. In the preferred embodiment there are preferably ten or more partitions on a tape or other media. As will be seen below, the partition structure is designed to permit maximum restorability of the tape or other media in case of error or disaster. It is a feature of the invention that the digital medium on which the video signal is recorded is partitioned into a plurality of independent volumes called partitions, and a portion of the signal is recorded to each partition. Here, “partition” has its common meaning in the digital recording field; that is, as a verb, it means to divide the medium into independent volumes. As a noun, a partition is an independent volume of a digital medium. For example, if a hard disk is partitioned, disk space is allocated to a plurality of different volumes, and each volume behaves as a physically distinct hard disk, and similarly for a tape or a solid state memory.

The signals from storage media 1170 is fed through output 1162 to NMEG In/Preview input 1193 to output system 1186. Output system 1186 includes a decoder module 1187 including video/audio decoders 1188, on-screen display control electronics 1194, and abstract decoder module 1190. Abstract decoder module 1190 is designed to be compatible with all or nearly all off-the-shelve video decoders. Thus, many different video decoders, such as a direct show decoder, a canopus decoder, a DVD plus decoder, a Vweb decoder, a solid state decoder or anyone of future decoders that become available may be used with the system 1186. The customer can specify which decoder is preferred, and one or more of the decoders shown may be incorporated into a specific system. On-screen display control 1194 includes the inputs 1195 to control the on-screen display, which inputs include initialize, de-initialize, bit map display, text display, and flip page. Input module 1102 also includes user activated inputs 1192, such as initialize, de-initalize, step n, start and stop, pause, and set position. Other video encoder parameters may also be set as known in the art. The encoded signal is output at output 1191 to video display module 1196, which generally is a computer, and thus the video may be either a Windows™ display 1197 of a Linux video display 1198.

Control module 1199 controls the digital settings for the system, preferably in XML or INI, and feeds control signals to the rest of the system via outputs 1199a, 1199b, 1199c and 1199d.

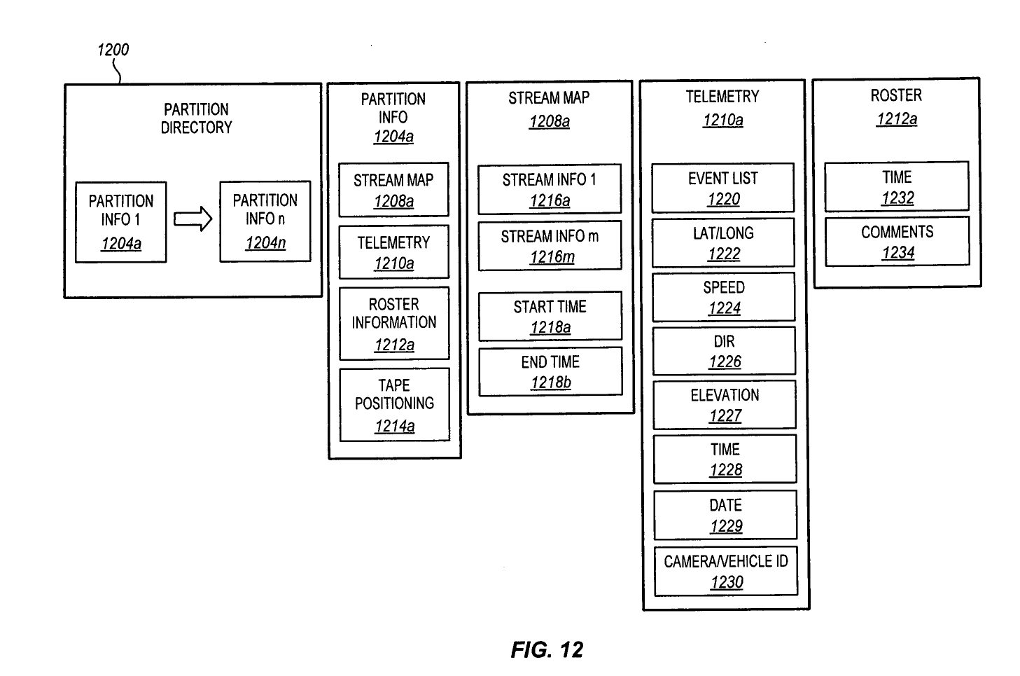

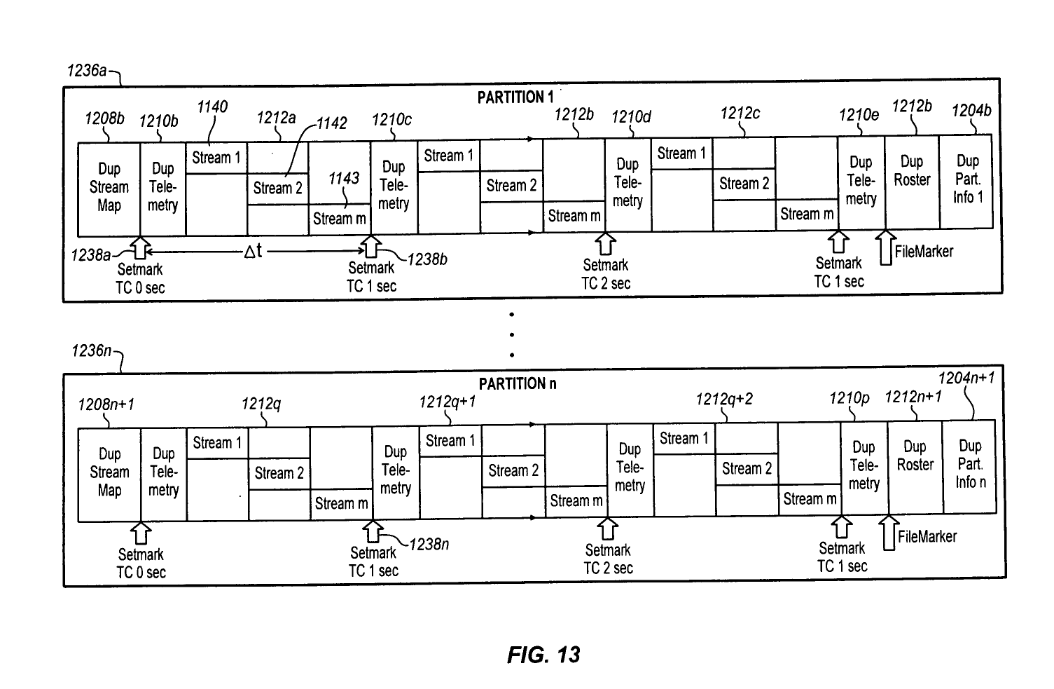

FIG. 12 is a diagram illustrating a partition directory 1200. As will be seen below, for redundancy, this directory is written into at least four separate places in the surveillance system. Directory 1200, includes a partition information 1204 for each of n partitions, where n is preferably ten or more. That is, as digital video is written onto the digital tape in partitions, each partition will include a partition information at the end of the partition. In addition, the partition information 1204a-1204n (collectively 1204) is also written to a separate partition directory 1200.

Partition information 1204a preferably includes a stream map 1208a, telemetry 1210a, roster information 1212a, and tape position information 1214a. It should be understood that the partition information 1204a may include different and/or additional information associated with the digital video stored in a particular partition. Each or the n partitions will include this information.

Stream map 1208a preferably includes video stream information 1216a-1216m (collectively 1216) that includes information associated with the digital video stream. The stream 1208a preferably further includes start time 1218a and end time 1218b of the video segment. Different and/or additional information associated with the digital video stream maybe included in the stream map 1208a.

The telemetry 1210a preferably includes data indicative of physical or other parameters during the recording of the surveillance video. In one embodiment, the telemetry 1210a includes an event list 1220 (e.g., shotgun removed from cradle, chase, robbery in progress, accident), GPS location in latitude/longitude 1222, speed 1224, direction 1226, elevation 1227, time 1228, date 1229, and camera or other video input or vehicle ID 1230. Other parameters may also be recorded, including temperature, lighting conditions, vehicle number, or any other parameter useful to providing information associated with the surveillance video at a later time.

Roster 1212a preferably includes time parameter 1232 and comments 1234. Comments 1234 may include comments entered by an operator on a computer associated with a video source, for example. Time parameter 1232 is preferably the time the comments were made, or other time associated with the comments. Different and/or additional information may be included in the roster 1212. The record is searchable by any information in the partition directory, including, but not limited to, any information in the stream map, the telemetry, and roster.

A feature of the invention is self-authentication. By self-authentication is meant that the recording can be authenticated, that is, shown to have not been tampered with or forged, with only the record itself and the playback system. That is, only the recorded tape, hard drive, solid state memory, or other medium on which the video is recorded and the playback system with authentication software are required to authenticate the record. For example, U.S. Patent Publication No. 2002/0131768 published Sep. 19, 2002, discloses an authentication method that uses encryption and requires a court or other authenticator to have an encryption key to authenticate the record. Thus, that system is not self-authenticated since it requires something outside the record itself and the playback system for authentication. One example of a self-authentication method is the hash value 534 discussed in connection with FIG. 5 above. We have discovered that the multiple time values included in the record, including stream start times 1218a, end times 1218b, telemetry time 1228, and roster time 1232, and the facts that these times are take from a reliable, traceable source, which preferably is the official GPS time, and included to at least a tenth of a second, and preferably to a hundredth or thousandth of a second, and the many times the telemetry is duplicated in the record, provide highly reliable self-authentication. If any frame is changed, these times will not be internally consistent and tampering will be evident. In other embodiments, the time could be taken from an atomic clock.

FIG. 13 is an illustration that illustrates one embodiment of a partition structure of a tape or other storage media 1170. Each tape or other media preferably includes a zeroth partition that includes the partition information as shown in FIG. 12. Each tape or other media also includes partitions 1236a through 1236n (collectively 1236) which include the video/audio and other data as illustrated in FIG. 13. Partitions are generally set up when the tape is formatted. Each partition 1236a through 1236n includes a variety of information that provides for the redundant, fault-tolerant nature of the system and provides for fast seeking capabilities. Partition 1236a includes duplicate stream map 1208b, duplicate telemetries 1210b-1210e, duplicate roster information 1212b, and duplicate partition information 1204a. Digital video stream or content segment 1212a includes portions 140, 142, 143 of multiple video streams, video streams 1-m, that are multiplexed from the multiplexer 910. In the preferred embodiment, the video stream segments are synchronized in time; that is, the portions 140, 142, 143 are all recorded in the same time frame. The video stream portions 140, 142m 143 need not have the same format or utilize the same bandwidth. Similarly, partition 1236n includes duplicate stream maps 1212q, 1212q+1, and 12q+2, duplicate telemetries, duplicate partition information 1204n; and digital video stream or content segment 1212a includes portions of multiple video streams, video streams 1-m, that are multiplexed from the multiplexer 910. For simplicity, each partition is shown with three segments of video stream, though preferably each partition will often include many more segments. Generally, a segment ends when taping is interrupted, such as when the user stops recording. A segment will also end at the end of each partition and a new segment begins the next partition. Because duplicate stream maps 1208b-1208n+1, duplicate telemetries 1210a-1210p, and duplicate roster information 1212b-1212n+1 are written into each partition 1236a-1236n, a loss of data in an earlier partition is not fatal to reading the remainder of the digital tape. Also, the duplicate partition information 1204b-1204n+1 written into each partition provides further redundancy to ensure that the content stored on the digital tape is recoverable.

To enable fast seeking of video without having to read and uncompress the compressed video and stream map 1208a to read the video segment time 1218a-1218b, one embodiment includes markers 1238a-1238r (collectively 1238). In the embodiment shown, the markers are sound or optical markers placed onto the digital tape with a regular period. A one second period is shown, but other periods may be used, such as every half-second or every 1.5 seconds. In this embodiment, these markers 1238 are real-time markers indicative of the relative time after recording of the surveillance video starts and are independent of the digital video signals. In other embodiments, the markers may be markers that are generated by an algorithm, or markers pointing to the location of the directory information and stored in memory 1604 (FIG. 16). If the markers are generated in an algorithm, the algorithm will preferably be stored in memory 1604. The key point of the markers is that the markers provide a system that points to the location of the directory information, such as stream maps and telemetry, which system is independent of the compression scheme. That is, markers 1238 do not go through the compression process. The markers are special signals recorded by the tape system, which allow the tape to find these markers at full seek speed without actually reading the data on the tape. The full seek speed is preferably 400 times faster or more than normal playback speed. These tape markers as shown in FIG. 13 are used to mark the beginning of a “new stream” and enable the system to quickly reconstruct an index directory if the need should arise. It also frees the system from counting bytes and forcing it to read the data from the tape constantly, which fails if a bad tape spot occurs. As shown, preferably the duplicate telemetry 1210b-1210p is written after each marker. A special case of a marker is a file marker 1239 which is written just before the duplicate partition information, such as 1204b. A file marker may be a sound or optical signal, or a marker stored in memory 1604, that contain 64 bytes of alphanumeric information that points to specific information in the data.

The system, in accordance to the principles of the present invention, incorporates another level of fault tolerance, which is accomplished with logically breaking a tape into multiple independent partitions. Typically, the tape is segmented into ten or more independent tape partitions. By segmenting the tape, the tape system can withstand even a massive failure on tape (such as a wrinkled tape). A conventional tape system cannot continue with such a failure. However, with a multi-partitioned tape, the system deems this partition as unusable and simply skips to the next partition. During recording, there is no loss, as it automatically skips. During playback, the maximum possible loss with such an error would be a partition worth of blank video. In most cases, data written up to the error situation is intact. Since the tape system skips immediately upon trouble, the data resumes on the next partition.

Playback and Display

The system according to the invention can track a single incident from multiple camera angles and, preferably, with multiple audio tracks, with the time and location synchronized. The record is searchable by time, date, vehicle ID, GPS location, and event. Any of these elements, such as GPS location, can be displayed for each stream, i.e., each camera. Zoom and pan can be controlled individually for each stream during playback. The system also permits frame by frame search, generally using time as a locator. Brightness, contrast and saturation can also be controlled individually for each stream, Likewise, each audio channel can be individually controlled. Segments of a recording can be easily clipped and copied to a disk or other medium.

Interruptible Video Stream

As many users have experienced, it is also usually fatal to have any kind of data corruption in digital data. Any corruption to the data stream itself normally would prove to end a fate similar to any program that has a few bytes in the wrong place. Since the present system is intended for streaming video, advantage is taken of the streaming MPG standards, which periodically insert start codes into the video stream. These are markers into the video data indicating the re-sync point. These start codes find and re-synchronize the video stream should a portion of the data be corrupt. The longest video length that could be lost after a corruption is a maximum ½ second, as the system automatically picks up where it left off once the corruption area has been passed.

With the redundant nature of the tape index and the ability for the stream to re-synchronize again even after a major tape corruption, the present system is extremely fault tolerant and suitable for any mission critical application.

Full Index Reconstruction

Should the need arise to reconstruct a new index, the tape system goes into full fast forward mode looking only for tape markers. Once a tape marker is found, the tape automatically slows down and starts reading the first block after this tape marker. This block is the redundant demarcation block, which contains all the information needed to retrieve the stream's name and information. Should this first block be corrupt, the tape simply continues to read until it reaches another demarcation block, which is normally just a few seconds ahead, until it reaches a good block. The index in this system does not record the relative byte offset to the stream, but counts the tape markers to reach it. Since the tape can seek at its highest speed, and because it does not need actually to read the tape to search for tape markers, it does not get hung up on the first tape read error. Also, the tape directory cannot be corrupt, bad, or missing due to the fact that there are streams on the tape, which are enough to fully re-construct an index; the demarcation blocks hold a directory entry for the stream.

This process is done until the end of tape is reached (indicated by a special tape marker). At this point, the index reconstructed in memory is compressed and written to the EEPROM on the tape once again.

Tape Marker Seeking

Once an entire tape index is created, it is known how many tape markers to count either forwards or backwards from any point on the tape to quickly seek to the stream being sought, which is the same as performing a byte count as understood in the art. There is some optimization information also stored with the index, gleaned from the next and previous demarcation blocks. This allows for predetermining a particular stream and to seek within that stream.

Even without a tape index ever being created, striping a tape to hard disk can happen instantly if starting from the beginning. A tape can also have large tape errors on it, as long as they are contained within a stream. A seek to the next tape marker can be performed and other streams can be read.

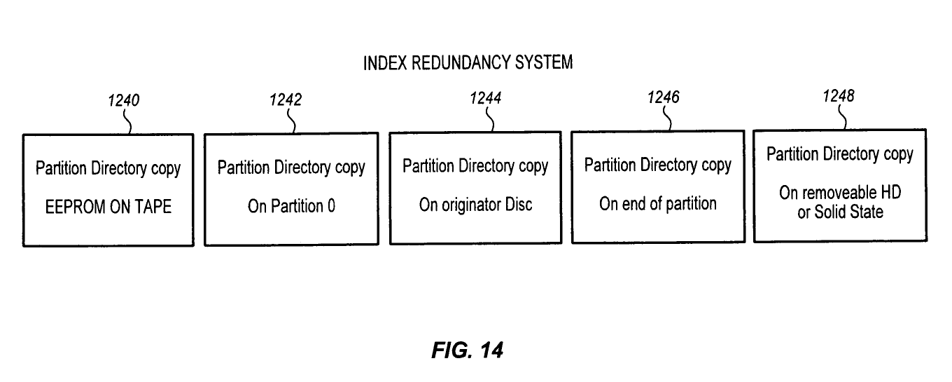

As discussed above, the invention provides a redundant system that records simultaneously to both a hard disk 146, 815a, 815b and to a tape 199, 840 in tape drive 144, 822. The hard disks maybe removable, for further redundancy. Further redundancy is provided by semiconductor memory 823 and CD burner 824. FIG. 14 illustrates the preferred embodiment of a index redundancy system such that loss or corruption of one index is not fatal to recovery of the content on the digital tape. As shown, there are five copies of the partition directory that are written, including one copy on a memory (e.g., EEPROM) on the digital tape at 1240 (see also FIG. 16), one copy on partition 0 of the digital tape at 1242, which was discussed above, one copy on an originator disc at 1244, one copy 1245 at the end of each partition, which also was discussed above, and one copy 1248 on a removable hard drive or solid state memory. Not all of these redundant directories may be used, but preferably at least three are used. This level of redundancy makes it virtually impossible to be unable to recover the partition directory, thereby ensuring robustness of the digital tape or other recordable media 1170.

Another factor in the architecture of the present system is also to incorporate a built-in automatic data recovery system such that no extraordinary measures are needed to recover data should there be a massive failure to the system. The first phase of the data recovery system is to store the tape index information redundantly using different technology for each instance as shown in FIG. 14. Most unrecoverable errors are typically due to loss of critical information, such as a directory. In prior art systems, perfectly good data is worthless if the directory is corrupted. In the system of the invention, the chance of a simultaneous failure in all systems is highly unlikely. Any one or two failures on any system will cause the system to automatically repair the failed system from the remaining working system.

As mentioned in connection with FIG. 14, an embedded flash-prom 1404 is built into every cassette tape 1330b (FIG. 16), and a partition directory 1240 is written to the flash-prom. This is a primary system allowing not only near-instant access to content directory, but also a “tapeless” method to hold the index. Incidents that may cause errors in the tape generally do not affect the flash-prom, and vice-versa, thus, the combination is essentially error-free.

There is a dedicated tape partition 1242 for the index. This index mirrors the primary system and is used only in the case of errors in the primary system. Normally, this is only accessed in case of trouble, as it does introduce a delay and tape re-positioning not present in the primary system.

There is also a partition directory copy 1246 at the end of data for each partition. Once a video segment is created, and before the tape is re-positioned, the tape directory is duplicated at the back end on the current partition. This directory is only valid for all data previous to this position. However, it affords another level of redundancy available if any of the previous systems have a problem.

A disk index 1244 is also created on originating system, such as 814a, that streams the data to tape. This index is preferably stored on the originating system hard disk such as 815b. This index is a last resort if a tape should have a triple failure. Inserting the tape cassette, such as 840, into its originating video source, such as 822, will cause the system to automatically repair the tape.

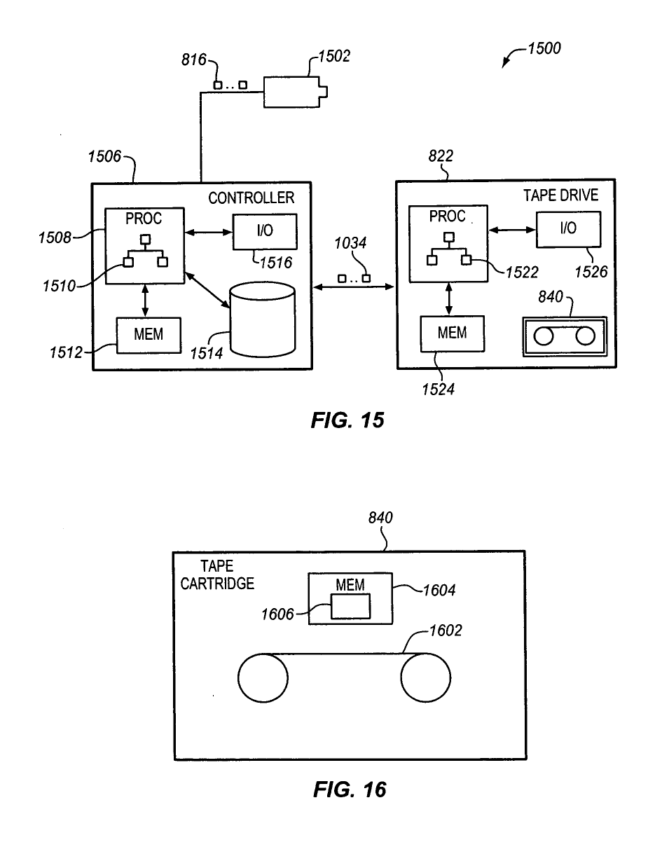

FIG. 15 is a simplified diagram of an exemplary surveillance system 1500 for capturing and writing data onto digital tape which is helpful in understanding the fail-safe redundant storage of the preferred embodiment of the invention. The surveillance system 1500 maybe utilized on a vehicle or stationary environment and may be any of the surveillance systems 102 (FIG. 1), 860, 870, 872, 874, and 880 (FIG. 8). The system includes at least one video camera 1502 configured to capture video and produce a video signal 816 (see also FIG. 8). A controller 1506, which is a generalized depiction of the electronics box 130 in FIG. 1, 860 of FIG. 8, and any of the servers or computers of FIG. 8, may receive the video signal 816 for processing. The controller 1506 may include one or more processors 1508 executing software 1510 for performing one or more functions to process the video signal 1504. A memory 1512, storage unit 1514, and input/output device 1516 all are in communication with the processor 1508. In one embodiment, the processor(s) 1508 executing the software 1510 performs the functions of compressing the video signal 1504 to generate a compressed video signal, splitting the video signal into a video and audio signal, and multiplexing the video and audio signals to generate a multi-channel content stream 912 (see FIG. 9). In addition, the processor(s) 1508 maybe configured to operate a sliding window 914 for writing the video signal 1504 to the storage unit 1514 (e.g., hard drive) prior to communicating the video signal 1304 to a tape drive 822. In one embodiment, the tape drive 822 is a Sony Advanced Intelligent Tape™ (AIT) tape recorder.

The tape drive 822 includes a processor 1520 that executes software 1522. Memory 1524, input/output device 1526, and tape drive 822 are in communication with the processor 1320. The tape drive 1328 is configured to write the video signal 1304 onto a digital tape 1330a. In the preferred embodiment, the tape deck 822 is configured to write set marks 1238 (FIG. 13) on the digital tape 1602 (FIG. 16) in substantially periodic intervals (e.g., every second). The tape drive 822 maybe preprogrammed to write the set marks 1238 on the digital tape 1602 without external commands to write the set marks 1238 from the controller 1506, for example, or configured to receive a command to write the set marks 1238.

FIG. 16 is a diagram of an exemplary digital cassette 1038 optionally utilized in accordance with the principles of the present invention to store content in a fault-tolerant manner and for fast retrieval of directory information. In one embodiment, the digital cassette 1038 is a Sony AIT-3 digital cassette, which has a memory in cassette (MIC) capability. The digital cassette 1038 includes digital tape 1602 and an electronic memory 1604. The electronic memory 1604 may be an EEPROM memory device or other electronically read/write memory device capable of storing information associated with content being written onto the digital cassette 1038. In the preferred embodiment, it is a 4K EEPROM. The information preferably includes directory information 1606 to provide quadruple redundancy of the directory information 1606 as described in FIG. 14. The use of electronic memory 1604 integrates well into the principles of the present invention. The use of the electronic memory 1604 to store directory information provides a substantially instantaneous look-up of the directory, as the tape need not be accessed to read the electronic memory 1604.

The EEPROM preferably hold a compressed directory, and preferably uses set mark or tape marker counts instead of byte counts to indicate correspondence of individual portions of the directory to the tape. Should a catastrophic EEPROM failure or corruption happen, the index can be reconstructed by searching for tape markers at full tape seek speed.

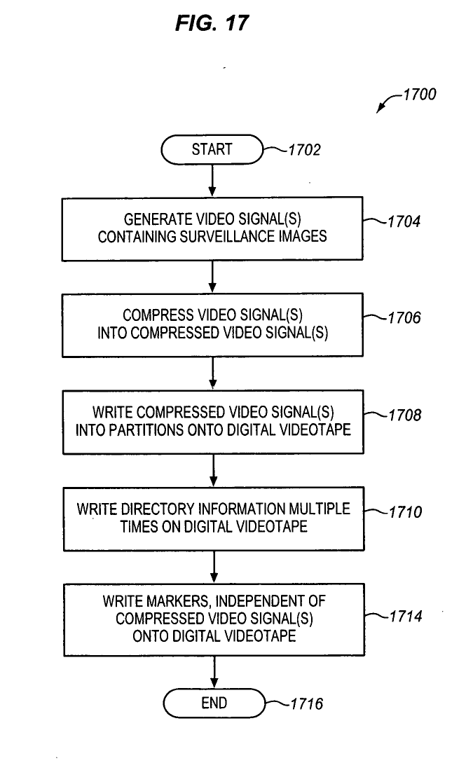

FIG. 17 is a flow chart describing an exemplary process 1700 for capturing and writing surveillance data onto digital tape in a fault-tolerant manner. The process 1700 starts at 1702 in which one or more video signals containing surveillance images are generated. The video signal(s) are compressed into compressed video signal(s) at 1706. At 1708, the compressed video signal(s) are preferably written into partitions onto a digital tape and directory information is written multiple times on the digital tape at step 1708. In one embodiment, the directory information is written into each partition, as discussed above. In the preferred embodiment, markers independent of the compressed video signal(s) are written onto the digital tape at 1714. The process 1700 ends at step 1714.

The system architecture revolves around the design goal of minimizing the loss of video. Under any realistic circumstances, the content is recoverable. While the data is being written, is the most sensitive time. Thus, during this time the data is stored on disk, tape, and/or a solid state memory. Once the data is written, it can be duplicated to a library and preserved as needed. In addition, the data is a recoverable by a number of user-serviceable processes, meaning no special recovery software is needed. In the prior art, what the tape has physically recorded and what the system thinks it recorded could be out of sync due to video still in the tape drive cache or pending memory buffers waiting to be transferred, but not physically written. The prior art systems relied on a directory structure that had to be in sync with the data on tape and hard disk. Due to the nature of the surveillance business, it is often the case that the tape video system (TVS) would be put in unstable situations; e.g., when power is suddenly turned off before the directory could be written, when the tape recovery operation is interrupted , etc. For example, anything from a brief power outage to an explosion could put the video data in jeopardy, as everything on tape would be considered lost if the directory was corrupt. The system, in accordance with the principles of the present invention, may perform its resume operation by relying on the total data written to tape, which is easily determined via the partition information, and performing a calculation to determine where the data was interrupted from the disk mirror. This process provides reliability, the blocks written to tape as well as a starting time are known for certain.

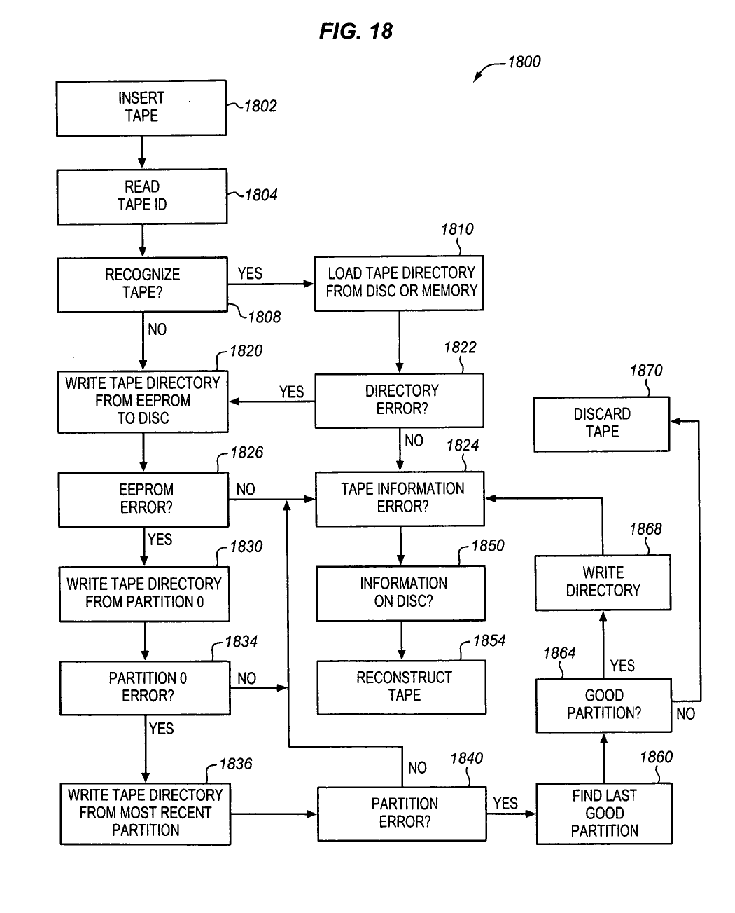

In keeping with the absolute reliability goal, the surveillance system according to the invention is designed to automatically correct tape errors and automatically take action to prevent tape defects from corrupting data. In the worst case scenario where data is corrupted on a tape, the tape will automatically reconstruct the data if possible. FIGS. 18, 19 and 20 illustrate the preferred embodiment of how this is done. FIG. 18 illustrates one embodiment 1800 of how the system checks itself for errors and corrects them upon insertion 1802 of the tape cassette 199, 840 into the tape deck 144, 822. Each tape has a tape identification recorded on it, which ID is read at 1804 upon insertion of the tape cassette. If the system recognizes the tape at 1808, the tape directory already in memory, which can be the hard disk 146, 815 or a semiconductor memory 127, 823, is loaded. If this directory is found to have an error at 1822, the system then goes at 1820 to the solid state memory 1606 for its directory. For example, if a cassette is merely removed for some reason and then re-inserted, the system recognizes this as well as all prior operations performed on the tape, and is immediately ready to continue recording or reading upon insertion. However, if a tape cassette is swapped out for a new cassette, the new cassette will not be recognized and the system proceeds at 1820 to write to disk the tape directory from the tape electronic memory 1606. If an error is recognized at 1826 during this read, the system will go to one of the partition directories, which preferably is the partition zero. At 1830 the partition director will be written to disk, but if an error is also found there at 1834, then the system proceeds to the duplicate directory in the most recently written partition on the tape and writes this directory to hard disk at 1836. If this is also corrupt, the system will find the last good partition at 1860 and when it finds it at 1869, it will write its directory to hard disk at 1868. If this partition is also bad, the tape will be rejected at 1870. If during the insertion process a tape error is found at 1824, which error reflects a loss of information, the system will automatically look to see if the information is available on the hard disk or elsewhere, and reconstruct the tape information at 1854.

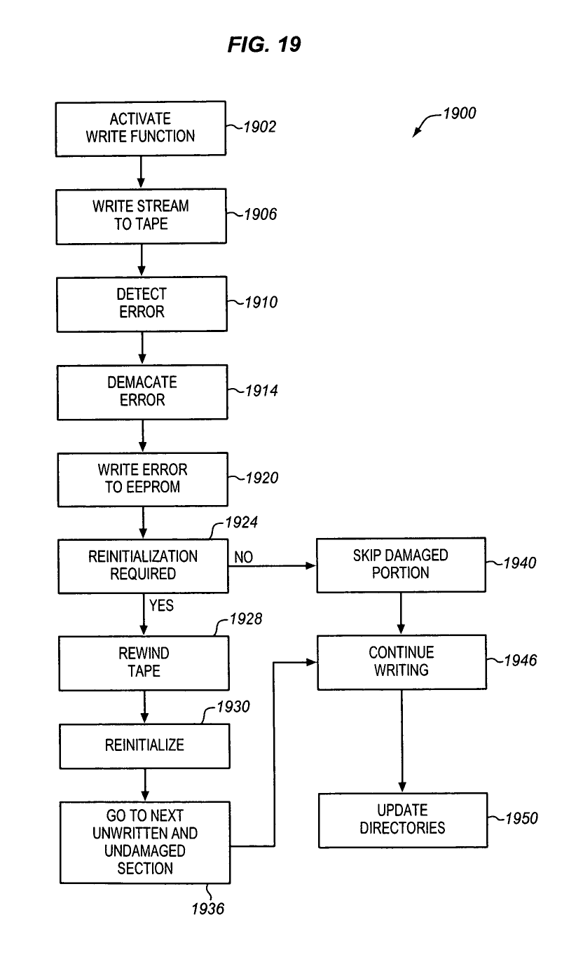

FIG. 19 illustrates one embodiment 1900 of how the tape self-corrects during the write function. At 1902 the write function is activated and writing proceeds at 1906. If during the write process an error is detected at 1910, the type and position of the error will be demarcated at 1914 and this information will be written to the partition director in the electronic memory 1606 on the cassette. If the error is such that re-initialization is required, this is determined at 1924 and the tape is rewound at 1928 and re-initialized at 1930. Once resynched, the tape will find the next unwritten and undamaged section of the tape at 1936 and continue writing at 1946. If re-initialization is not required, the tape will skip the damages section at 1940 and the continue writing at 1946. All directories are updated at 1950 once the tape settles back down.

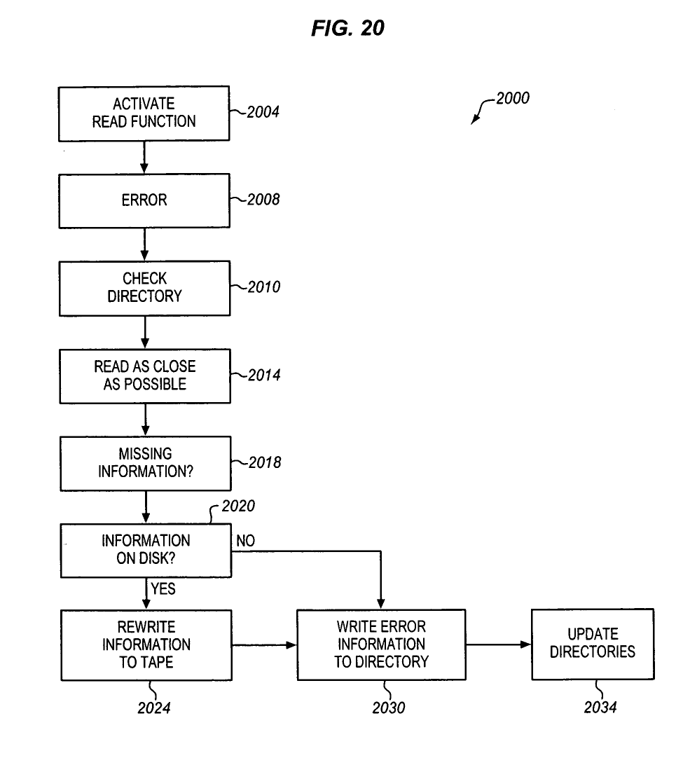

FIG. 20 illustrates one embodiment 2000 of how the tape self-corrects during a read function. The read function is activated at 2004 and if an error is found at 2008, the directory, most preferably on the hard disk and preferably, the tape memory 1606. Using the information from the directory, the tape will read as close as possible to the error to maximize the amount of date recovered. If data is still found missing at 2018, the system will look to the disk for the data and rewrite-the data to the tape at 2024, then record the corrected information to the directory at 2030. If the data is not available, the system will proceed to write this information to the directory at 2030. Then, all the duplicate directories are updated at 2034.

The system of the invention provides zero down-time recording. As discussed above, the recording can be reviewed and recorded simultaneously. The writing to disk, the buffers, and the partition information allow the tape to be swapped while the system is being used. The system also includes a software function that permits pre and post event recording for from ten seconds to two hours before and after an event.

The system is capable of producing native MPG format directly, which increases the recovery ability by the user at multiple levels. Should anything happen to the tape, a backup version is available to the user, either an entire tape can be re-created from scratch, or the video can be off-loaded from the tape video system via many methods either via a network or locally.

The system incorporates true embedded multi-channel recordings. Instead of using one MPG per channel, all channels maybe merged into a single MPG file. This enables synchronization between channels, ease of editing/clipping, and ease of maintaining archives of video, since each channel maybe integrated into a single file.

Via the abstract encoder and decoder systems, the system provides native support For MPEG-4 Part 10 (H.264) and MPEG-4. The system is designed to handle newer compression schemes without change to the recording pipeline or format of the tape. As a result, the system is capable of recording any MPG standard compression scheme.

In addition to handling a variety of compression schemes, it is not necessary for all channels to have the same bit rate, or, for that matter, even use the same compression scheme. In one embodiment, one channel maybe configured for a MPEG-2 hi-bit rate and another channel for H.264 low bit rate. This allows for flexibility to choose how to allocate total bandwidth instead of dividing evenly between video signals. Thus, a primary camera can be given a bit rate that has the highest quality, and the back-up cameras can share a lower bit rate, without sacrificing the video quality of the primary camera.

The design of the system has no upper limit imposed on the number of true independent channels it can handle. There is a practical limit based on recording time and capacity of storage, but other than that, there is no limit. For example, eight or more channels are easily achievable.

The system includes built-in full SSL security Web server technology. The system preferably includes the ability to web-enable any capture box, to allow for web access of the video and/or control. Users can remotely monitor their tape video system from anywhere in the world. In addition, no unauthorized access is possible. In one embodiment, the same security features that PayPal™ uses to secure money transactions to millions of people is utilized to secure content stored in the tape video system. Additional and/or alternative security features may be utilized to maintain unauthorized access to the tape video system. The tape video system includes wireless access, thereby allowing mobile systems to be monitored by either pulling up to a designated monitoring bay or even using a simple Pocket PC to monitor it.

A user interface (“Command Center”) maybe completely web-based, thereby giving the user flexibility in accessing content stored on the tape video system via web-based playback and monitoring. Because the system may be web-based, users do not need a copy of the application resident on a local computer to access and utilize the system. A user may simply logon to the system's TVS box with Internet Explorer or other web application and the web page presented is the Command Center. No sacrifice has been made to the functionality for this. The web-based technology will pass through firewalls; in fact, it acts just like a normal web page. It allows users to run on or off site. If a user prefers, the user can visit a system website and run the user interface from there. The web-based user interface accesses only the customer's local files for tape and disk playback Because the Command Center is completely web-based, a custom functionality and look can be done quite easily.

The tape video system makes a great core component for many other video-based applications. To leverage this even further, a tape video system can be fully controlled and video manipulated via a built-in PHP server-side script engine as understood in the art. Any type of application that can be envisioned can be scripted directly on a tape video system without changing the application. The system provides fully database-driven video playback and multiple tape video system servers networked together. Because of the industry standardized PHP engine, many existing PHP applications can be run directly on the tape video system. In combination with the built-in web-based server, the system's networking ability, and its built-in telemetry clock, it is possible to create huge synchronized capture arrays for such things as stadiums, football fields, casinos, or street traffic. There is no upper performance limit in this case, and a 100-camera system, all monitored by a single administrator either on or off site anywhere in the world, is possible.

The tape video system incorporates a built-in telemetry system. Not only does the system record the video/audio, but it also embeds telemetry into the stream, the location of the system, the elevation, and even the speed of travel of the capture system, among other parameters. This is valuable for indisputable court evidence.

The tape video system provides the highest quality video possible with today's technology. It can handle the highest amount of full D1 resolution cameras, the highest quality, the highest recording capacity, and the highest specifications for mission critical applications in the industry. The system, according to the principles of the present invention, embodies several innovations for the implementation of ultra-large real-time recording and playback of video to cartridge tape as a completely digital process. These innovations permit streaming media to/from tape in a manner analogous to a recordable DVD. The advantages of streaming media to/from digital tape over other digital methods (such as DVD, CD-ROM, or even a hard disk) include higher capacity and resolution, increased durability, and additional fault-tolerant capability.

Table B below compares the present system of streaming tape utilizing the principles of the present invention with other conventional recording media. In this table, “Shock Resistant” means that the system can record/play without trouble during a slight shock such as is common in mobile environments. Serious Error Recovery means that the system can recover from a serious permanent error, during recording or playback. Removable Media includes that the recording medium is removable, economical, and replaceable. DVD and CD-ROM are recordable but limited in that recording is a once-only operation, and is not capable of start-stop recording. While a hard disk can handle moderate shocks, but will be destroyed in a removable application if dropped. Although analog tape will continue to record during a shock, it will produce many undesirable artifacts for several seconds after the initial shock.

TABLE B

| | Max | | Shock | Serious Error | Removable |
|---|---|---|---|---|---|
| Technology | Capacity | Recordable | Resistant | Recovery | Media |
| Present System | Up To 500 | Yes | Yes | Yes | Yes |
| Of Streaming | Gigs | | | | |
| Tape | | | | | |
| DVD | 8 Gigs Max | Yes, with | No | No | Yes |
| | | limitations | | | |
| Blue-Ray | 17 Gigs | No | No | No | Yes |
| HD-DVD | 35 Gigs | No | No | No | Yes |
| CD-ROM | 800 Megs | Yes, with | No | No | Yes |
| | Max | limitations | | | |
| Hard Disk | 100's Of | Yes | To a degree | Yes | No |
| | Gigs | | | | |
| Analog tape | Equivalent | Yes | No | Yes | Yes |
| | To 4 Gigs | | | | |

The only other media having competing capacity to the system of the invention is a high-capacity hard drive. However, such a large hard drive is not practical for removable media applications from a cost standpoint. The other possible removable media types, such as CD-ROM, DVD, HD-DVD, and Blue-Ray, lack any real capacity comparable to the present streaming tape system. In addition, they are totally unusable for recording in a mobile environment, since the slightest shock can render the entire recording unusable. None of these removable media types can withstand bumps and shocks while recording and playing back with no artifacts present. In addition, these removable media types are not typically recordable; and, if they are, they possess the ability to record once, as in the case of DVD or higher.

Other features by using digital tape for the removable media in a surveillance system include: the system can record multi-channel synchronized video (multiple camera recordings at once); the system can record to inexpensive, convenient, rugged cartridge tape, with many more hours of recording than all the existing and future planned streaming devices; excellence in recording and playback of HDTV resolution video; cartridge tape is more rugged and shock resistant than all other forms of storage; and ability to integrate additional digital information other than video, such as telemetry, roster information, subtitling, on-screen display information, synchronization information, etc. while still maintaining high quality.

The system can record up to broadcast-quality video from up to 16 cameras attached to a single recording device. In addition to traditional video, the system also records audio and GPS information to authenticate the exact time, date, and location of events, providing the ultimate solution for surveillance applications. Video is recorded to standards-based video formats that can be played back on any standard PC, which provides flexibility and interoperability when managing or reconstructing incidents.

While virtually all solutions currently available in the mobile digital video surveillance market are disk-based, the present system uses both hard disk and removable digital tape storage to provide critical backup support and an economic advantage. The system also provides a method of archiving large video files to removable digital tape that are consistent with broadcast quality MPEG-2 DVD.

The system according to the invention provides ease of use and flexibility, minimal downtime, and multi-partitioning. It is also an economical solution with a low cost-per-gigabyte, while delivering superior performance, density, and reliability.

The system is configured to provide small form-factor, high capacity, and reliability needed for demanding security applications at a reasonable cost. The system may further be configured to provide a full-motion, high-resolution video surveillance system with a highly reliable, removable storage solution to manage mission-critical needs.

The tape drives of the system may include helical-scan recording, highly durable advanced metal evaporated (AME) media formulation, and a performance enhancing memory-in-cassette chip. One embodiment of the system features a range of capacities and performance solutions up to 200 GB native storage capacity and sustained native transfer rates of up to 24 MB/second.

The system is operable to provide zero downtime recording using broadcast-quality video with four and a half times the resolution of other digital systems, making it superior to other digital or analog security systems on the market today.

The system may also be configured to provide a true 24/7 recording of over 240 hours of continuous broadcast-quality video on Sony AIT-3 digital tape with no manual intervention. The Sony Advanced Intelligent Tape™ (AIT) platform was selected as the removable digital tape storage technology because it provides high-capacity storage for data security and archiving, high-speed file location and file access, backward read and write compatibility, and write once, read many (WORM) functionality.

Although the system described herein is directed to surveillance systems, it should be understood that the principles of the present invention could be applied to non-surveillance systems. For example, because the system is configured to handle video streaming, it should be understood that the system could be used with movies or other video recordings. Further, the same principles could be applied to audio signals or other continuous streamed digital information that would benefit from the use of large storage media with high-speed searching capabilities, including telemetry and other recording systems.

It should be understood that the particular embodiments shown in the drawings and described within this specification are for purposes of example and should not be construed to limit the invention, which will be described in the claims below. For example, although the system is particularly useful if MPEG-2 compression is used, any MPEG compression scheme, known now or in the future, may be substituted. In fact, since this is the first disclosure of any direct streaming of compressed audio/visual signal to digital tape, it is inventive to use any present or future digital compression scheme, for example, MJPEG sometimes referred to as motion JPEG (Joint Photographic Experts Group), and it is contemplated that the future versions of the invention will include hardware and software to utilize many other digital compression apparatuses and processes. Further, it is evident that those skilled in the art may now make numerous uses and modifications of the specific embodiments described without departing from the inventive concepts. It is also evident that the methods recited may in many instances be performed in a different order; or equivalent structures and processes maybe substituted for the various structures and processes described. Consequently, the invention is to be construed as embracing each and every novel feature and novel combination of features present in and/or possessed by the invention herein described.

What is claimed as new and desired to be protected by Letters Patent of the United States is:

1. A surveillance system, comprising:
a source of a video signal;
a video signal compression system electrically connected to said source and providing a compressed video signal;
a marker generator for generating markers independent of said compression, said markers indicative of specific content on said medium; and
a digital video recorder electrically connected to said compression system for writing said compressed video signal to a recording medium and for writing said marker to said medium, said markers being readable independent of said compressed video signal.

2. A surveillance system as in claim 1 wherein said markers are timing markers recorded on said medium at predetermined time intervals.

3. A surveillance system as in claim 1 and including a marker read system for reading said markers.

4. A surveillance system as in claim 3 wherein said marker read system is selected from an electronic reader and an optical reader.

5. A surveillance system as in claim 4 wherein said marker read system generates a sound.

6. A surveillance system as in claim 2 and further including a timing marker counter for counting said timing markers without reading said compressed video signal.

7. A surveillance system according to claim 2 wherein said timing markers are spaced on said tape one second or less apart from each other.

8. A surveillance system as in claim 7 wherein said system includes a marker reader for generating sound signals from said markers.

9. A surveillance system according to claim 1 wherein said specific content comprises directory information regarding the location of data on said medium.

10. A surveillance system as in claim 9 wherein said data comprises telemetry signals.

11. A surveillance system as in claim 10 wherein said medium is a digital tape.

12. The surveillance system as in claim 11 where said telemetry signals are recorded on said tape following said marker signals.

13. A surveillance system as in claim 1 wherein said recorder is a digital tape recorder and said recording medium is a digital tape having a semiconductor memory incorporated in it, said compressed video signal is written to said tape, and said markers are written to said semiconductor memory.

14. The surveillance system as in claim 1 wherein said surveillance system is mounted in a mobile vehicle.

15. A surveillance system as in claim 1 wherein said video compression comprises MPEG compression.

16. A surveillance system as in claim 1 wherein said video compression is selected from the group consisting of MPEG-1, MPEG-2, MPEG-4 and H.264.

17. A surveillance system as in claim 1 wherein said video signals are high density (HD) video signals.

18. A surveillance method, comprising:
generating a video signal containing surveillance images;
electronically compressing said video signal into a compressed video signal;
generating data associated with said compressed video signal;
recording said compressed video signal and said data onto a digital tape cassette, said tape cassette having a semiconductor memory incorporated into it; and
writing markers into said semiconductor memory, said markers designating where specific portions of said compressed video signal or specific portions of said is located on said tape.

19. A surveillance method as in claim 18 and further comprising reading said markers without reading said compressed video signal.

20. A surveillance method as in claim 25 wherein said generating data includes generating a start time and an end time associated with said compressed video signal.

21. A surveillance method as in claim 18 and further comprising;
partitioning said compressed video signal into a plurality of partitions, each said partition including a portion of said compressed video signal; and
using said markers to find a particular one of said partitions.

22. A surveillance method as in claim 18 wherein there are a plurality of said video signals, said electronically compressing comprises forming a plurality of streams of compressed video signals, each stream corresponding to a different source of said video signals, said method further comprising using said timing markers to locate one or more of said streams.

23. A surveillance method as in claim 18 wherein said data further comprises telemetry data associated with said video signal and said method further comprises using said markers to find said telemetry information on said tape.

24. A surveillance method as in claim 23 wherein said telemetry data includes time of day.

25. A surveillance method as in claim 23 wherein said generating a video signal is performed in a mobile vehicle.

26. A surveillance method as in claim 25 wherein said telemetry data includes one or more of the speed of said vehicle, the direction of said vehicle, the elevation of said vehicle, and an identification of said vehicle.

27. A surveillance method as in claim 18 wherein said video compression is MPEG compression.

28. A surveillance method as in claim 18 wherein said video compression is selected from the group consisting of MPEG-1, MPEG-2, MPEG-4 and H.264.

29. A surveillance method as in claim 18 wherein said video signals are high density (HD) video signals.

30. A surveillance method, comprising:
generating a video signal containing surveillance images;
electronically compressing said video signal into a compressed video signal;
recording said compressed video signal onto a digital tape; and
writing timing markers, independent of said compressed video signal, onto said digital tape, said timing markers being spaced on said tape in a predetermined time pattern.

31. A surveillance method as in claim 30, further comprising counting said markers written onto the tape without reading the at least one compressed video signs.

32. A surveillance method as in claim 30 wherein said writing timing markers comprises writing said markers in a periodic manner on said tape.

33. A surveillance method as in claim 30 wherein said timing markers are spaced two seconds or less apart on said tape.

34. A surveillance method as in claim 30 wherein said timing markers are spaced one second or less apart on said tape.

35. A surveillance method as in claim 30 and further comprising generating a sound from said timing markers.

36. A surveillance method as in claim 30 and further comprising counting said timing markers without reading said compressed video signal.

37. A surveillance method as in claim 30 and further comprising:
partitioning said compressed video signal into a plurality of partitions, each said partition including a portion of said compressed video signal; and
using said timing markers to find a particular one of said partitions.

38. A surveillance method as in claim 30 and further comprising:
receiving a time of day associated with said compressed video signal;
determining the number of said markers from a position of said tape to the compressed video signal associated with said time of day, and
moving said tape said determined number of markers and reading said compressed video signal.

39. A surveillance method as in claim 30 wherein said recording further comprises recording on said tape telemetry data associated with said video signals, and said method further comprises using said timing markers to find said telemetry data on said tape.

40. A method of video surveillance, said method comprising:
providing one or more video signals;
compressing said one or more video signals to form a plurality of streams of compressed video data; and
streaming a first of said video streams to via a first video channel while streaming a second of said video streams via a second video channel;
wherein said first and second video channels each has a different transfer rate.

41. A method of video surveillance as in claim 40 and further comprising placing a time indication on each of said streams, which time indication is effective to permit said streams to be synchronized on playback.

42. A method of video surveillance as in claim 40 wherein said transfer rate of said first and second video streams differ by 10 megabytes per second (MBPS) or more.

43. A method of video surveillance as in claim 41 wherein said transfer rate is variable on at least one of said channels.

44. A method of video surveillance as in claim 40 where one of said video streams is a conventional density video stream and another is a high density (HD) video stream.

45. A method of video surveillance as in claim 40 wherein said compressing comprises comprising compressing a first of said video streams according to a first video compression standard and compressing a second of said video streams according to a second video compression standard, wherein said first and second video compression standards are different.

46. A method of video surveillance as in claim 45 wherein said first standard comprises MPEG-1 and said second standard is selected from MPEG-2, MPEG-4 and H264.

47. A method of video surveillance comprising:
generating a video signal containing surveillance images;
generating self-authentication data;
electronically compressing said video signal into a compressed video signal;
recording said compressed video signal and said authentication data onto a digital medium; and
self-authenticating said recording of said compressed video data using said self-authentication data.

48. A method as in claim 47 wherein said generating self-authentication data comprises generating a hash value.

49. A method as in claim 47 wherein said generating self-authentication data comprises generating time data from a GPS source or an atomic clock and said recording comprises recording said time data on said medium at intervals of one second or less.

50. A method as in claim 49 wherein said recording is performed at intervals of one-tenth of a second or less.

51. A method as in claim 49 wherein said recording is performed at intervals of one-one-hundredth of a second or less.

52. A method of operating a video surveillance system, said surveillance system including: a video camera providing a video signal; a video signal compression system electrically connected to said camera and providing a compressed video signal; and a digital video recorder electrically connected to said compression system for writing said compressed video signal to a recording medium; said method comprising:
accessing a web site via a computer; and
operating said surveillance system via a program located on said web site.

53. A method of operating a video surveillance system as in claim 52 wherein said operating comprises manipulating a user interface on said web site.

54. A method of operating a video surveillance system as in claim 53 wherein said user interface accesses only the predetermined local surveillance files.

55. A method of operating a video surveillance system as in claim 53, and further comprising customizing the functionality and look of said user interface.

56. A method of operating a video surveillance system as in claim 52, and further comprising providing built-in full SSL security Web server technology on said web site.

57. A method of operating a video surveillance system as in claim 52 wherein said accessing is performed using a wireless system.

58. A method of operating a video surveillance system as in claim 52 wherein said video camera is located on a mobile vehicle.

59. A method of operating a video surveillance system as in claim 52 wherein said surveillance system is located on a mobile vehicle.
